(19) United States
(12) Patent Application Publication
(10) Pub. No.: US 2026/0221461 A1
(43) Pub. Date: Jul. 30, 2026

(54) SECONDARY BATTERY AND PREPARATION METHOD OF THE SECONDARY BATTERY

(71) Applicant: Samsung Electronics Co., Ltd., Suwon-si (KR)

(72) Inventors: Jinsuck Heo, Suwon-si (KR); Heungchan Lee, Suwon-si (KR)

(21) Appl. No.: 19/447,228

(22) Filed: Jan. 13, 2026

(30) Foreign Application Priority Data
Jan. 24, 2025 (KR) 10-2025-0011889

(51) Int. Cl. H01M 4/66; H01M 4/02; H01M 4/583; H01M 4/80; H01M 10/0562; H01M 10/058

(52) U.S. Cl. CPC H01M 4/661; H01M 4/583; H01M 4/664; H01M 4/667; H01M 4/80; H01M 10/0562; H01M 10/058; H01M 2004/027; H01M 2300/0077

(57) ABSTRACT

A secondary battery and a method of preparing the secondary battery. The battery including an anode current collector including a plurality of porous protruded portions and non-protruded portions between the porous protruded portions, a solid electrolyte including a plurality of uptake rooms, the plurality of uptake rooms accommodating the plurality of porous protruded portions, and an insulating layer between the non-protruded portions of the anode current collector and the solid electrolyte. The plurality of porous protruded portions include a metal-containing framework and an interlayer disposed on the porous metal-containing framework.

### CROSS-REFERENCE TO RELATED APPLICATION

This application claims priority to Korean Patent Application No. 10-2025-0011889, filed on Jan. 24, 2025, in the Korean Intellectual Property Office, and all benefits accruing therefrom under 35 USC § 119, the disclosure of which in its entirety is incorporated by reference herein.

### BACKGROUND

### 1. Field

The disclosure relates to a secondary battery and a method of preparing the secondary battery.

### 2. Description of the Related Art

Due to recent industrial demands, batteries with high energy density are required. Lithium batteries possess high energy density and are used in wireless earphones and electric vehicles. Also, because wireless earphones and electric vehicles can be in close proximity too, and in some instances in direct contact with consumers, operation safety of the batteries is of critical importance.

More conventional lithium batteries rely upon liquid electrolytes containing flammable organic solvents, which may lead to overheating and fire in the event of a short circuit. To address this issue, solid-state batteries that utilize solid electrolytes have been proposed and are of present interest.

### SUMMARY

Provided is a secondary battery having a novel structure capable of preventing volume change during charging and discharging.

Provided is a method of preparing the secondary battery.

Additional aspects will be set forth in part in the description which follows and, in part, will be apparent from the description, or may be learned by practice of the presented embodiments of the disclosure.

According to an aspect of the disclosure, a secondary battery includes:
an anode current collector including a plurality of porous protruded portions and a non-protruded portion between the plurality of porous protruded portions;
a solid electrolyte including a plurality of uptake rooms, the plurality of uptake rooms accommodating the plurality of porous protruded portions and being disposed on the anode current collector; and
an insulating layer between the non-protruded portion of the anode current collector and the solid electrolyte, wherein the plurality of porous protruded portions include a porous metal-containing framework and an interlayer disposed on at least a portion of a surface of the metal-containing framework.

According to another aspect of the disclosure, a method of preparing a secondary battery includes:
applying an interlayer on at least a surface of a porous anode current collector to provide an interlayer-coated porous anode current collector;
providing a solid electrolyte including a plurality of uptake rooms and an insulating layer disposed between the uptake rooms;
disposing the solid electrolyte on the porous anode current collector with the plurality of uptake rooms facing the porous anode current collector to prepare a laminate; and
pressurizing the laminate to accommodate the plurality of protruded portions of the porous anode current collector within the plurality of uptake rooms.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a cross-sectional view of an anode-solid electrolyte assembly included in a secondary battery according to an embodiment;

FIG. 1B is a cross-sectional view of an anode-solid electrolyte assembly included in a secondary battery according to an embodiment;

FIG. 2 is an partially enlarged view of a porous protruded portion in the anode-solid electrolyte assembly of FIGS. 1A and 1B;

FIG. 3 is a cross-sectional view of a solid electrolyte with an insulating layer introduced on the outermost surface according to an embodiment;

FIGS. 4A and 4B are cross-sectional views of a solid electrolyte in which an insulating layer is simultaneously disposed on the outermost surface and the bottom of the uptake room according to an embodiment;

FIG. 5 is a schematic view of a solid electrolyte including a plurality of uptake rooms having rectangular openings according to an embodiment;

FIG. 6 is a schematic view of a solid electrolyte including a plurality of uptake rooms having circular openings according to an embodiment;

FIG. 7 is a schematic view of a secondary battery including an anode-solid electrolyte assembly according to an embodiment;

FIG. 8 is a schematic view of a secondary battery including an anode-solid electrolyte assembly according to an embodiment;

FIG. 9 is a schematic view of a secondary battery including an anode-solid electrolyte assembly according to an embodiment;

FIG. 10 is a schematic view of a secondary battery including an anode-solid electrolyte assembly according to an embodiment;

FIG. 11 is a cross-sectional view of an anode current collector including protruded portions and a non-protruded portion according to an embodiment;

FIG. 12 is a cross-sectional view of an anode current collector including protruded portions and a non-protruded portion according to another embodiment;

FIG. 13 is a cross-sectional view of an anode current collector including protruded portions and a non-protruded portion according to another embodiment;

FIG. 14 is a schematic view illustrating a method of preparing an anode-solid electrolyte assembly included in a monocell-type secondary battery according to an embodiment; and

FIG. 15 is a schematic view illustrating a method of preparing an anode-solid electrolyte assembly included in a bicell-type secondary battery according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects.

Various embodiments have been illustrated in the attached drawings. However, the inventive concept may be embodied in many other forms, and should not be construed as limited to the embodiments described herein. Rather, these embodiments are provided so that the disclosure may be thorough and complete and to fully convey the scope of the inventive concept to those skilled in the art. The same reference numerals refer to the same components.

It may be understood that when an element is referred to as being “on” another element, it may be directly on top of the other element, or there may be other elements intervening between them. In contrast, when an element is said to be “directly on” another element, there are no intervening elements between them.

The terminology used herein is for the purpose of describing particular embodiments only and is not intended to limit the inventive concept. As used herein, the singular forms “a,” “an,” and “the” are intended to include the plural forms, including “at least one,” unless the context clearly dictates otherwise. The wording “at least one” should not be construed as limited to being singular. As used herein, the term “and/or” includes any and all combinations of one or more of the listed items.

It will be further understood that the terms “comprises” and/or “comprising,” or “includes” and/or “including” when used in this specification, specify the presence of the stated features, regions, integers, steps, operations, elements, components and/or ingredients, but do not preclude the presence or addition of one or more other features, regions, integers, steps, operations, elements, components and/or groups thereof.

Spatially relative terms such as “beneath,” “below,” “lower,” “above,” “upper,” etc. may be used herein for ease of description to describe one element or feature's relationship to another element or feature. It will be understood that spatially relative terms are intended to encompass different orientations of the device in use or operation in addition to the orientation depicted in the drawings. For example, if the device in the drawings is turned over, elements described as “beneath” or “below” other elements or features would then be oriented “above” the other elements or features. Accordingly, the exemplary term “below” may encompass both an orientation of above and below. The device may be otherwise oriented (rotated 90 degrees or at other orientations) and the spatially relative terms used herein may be interpreted accordingly.

Unless otherwise defined, all terms (including technical and scientific terms) as used herein have the same meaning as commonly understood by one of ordinary skill in the art to which this disclosure belongs. Additionally, terms defined in commonly used dictionaries should be interpreted as having a meaning consistent with their meaning within the context of the relevant art and the disclosure, and not in an idealized or overly formal sense.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10% or ±5% of the stated value.

Embodiments are described in the disclosure with reference to cross-sectional views of idealized embodiments. For example, variations from the shape of the drawing may be expected as a result of manufacturing techniques and/or tolerances. Therefore, the embodiments described in the disclosure should not be construed as being limited to the specific shapes of regions as depicted in the drawings of the disclosure, but should include, for example, deviations in shapes resulting from manufacturing. For example, regions illustrated or described as being flat may be rough and/or include nonlinear features. Moreover, the sharply illustrated angles may be rounded. Accordingly, the regions depicted in the drawings are inherently schematic, and their shapes are not intended to depict the precise shape of the regions or to limit the scope of the disclosure.

“Group” means a group of the Periodic Table of the Elements according to the International Union of Pure and Applied Chemistry (“IUPAC”) Group 1-18 classification system.

As used herein, the “particle diameter” indicates an average diameter of the particle when the particle is spherical, and indicates an average major axis length of the particle when the particle is non-spherical. The particle diameter of the particles may be measured using a particle size analyzer (PSA). The “particle diameter” is, for example, an average particle diameter. The “average particle diameter” is, for example, the median particle diameter (D50).

As used herein, “D50” refers to the particle size corresponding to 50% cumulative volume, calculated from the smaller particle size side in the particle size distribution measured by laser diffraction.

As used herein, “D90” refers to the particle size corresponding to 90% cumulative volume, calculated from the smaller particle size side in the particle size distribution measured by laser diffraction.

As used herein, “D10” refers to the particle size corresponding to 10% cumulative volume, calculated from the smaller particle size side in the particle size distribution measured by laser diffraction.

As used herein, “metal” includes both metals and metalloids such as silicon and germanium, in elemental or ionic states.

As used herein, “alloy” means a mixture of two or more metals.

As used herein, “electrode active material” refers to an electrode material capable of undergoing lithiation and delithiation.

As used herein, “cathode active material” refers to a cathode material capable of undergoing lithiation and delithiation.

As used herein, “anode active material” refers to an anode material capable of undergoing lithiation and delithiation.

As used herein, “lithiation” and “to lithiate” refers to a process of adding lithium to an electrode active material.

As used herein, “delithiation” and “to delithiate” refers to a process of removing lithium from an electrode active material.

As used herein, “charging” and “to charge” refers to a process of providing electrochemical energy to a battery.

As used herein, “discharging” and “to discharge” refers to a process of removing electrochemical energy from a battery.

As used herein, “cathode” and “cathode” refer to an electrode at which electrochemical reduction and lithiation occur during a discharge process.

As used herein, “anode” and “anode” refer to an electrode at which electrochemical oxidation and delithiation occur during a discharge process.

Although specific embodiments have been described, alternatives, modifications, variations, improvements, and substantial equivalents that may not currently be anticipated or foreseeable could arise for the applicant or those skilled in the art. Therefore, the appended claims, as filed and as amended, are intended to encompass all such alternatives, modifications, variations, improvements, and substantial equivalents.

During charging and discharging of a solid-state battery, the repeated deposition and dissolution of a lithium metal layer between the anode current collector and the solid electrolyte layer may cause structural changes in the battery's volume. As a result, stress or strain occurs in the thickness direction of the solid-state battery due to the volume changes during charging and discharging, leading to a degradation over time in charge-discharge performance. For example, the high-rate performance of the solid-state battery may deteriorate over time, e.g., following hundreds or more charge-discharge cycles. To suppress the volume changes during charging and discharging of the solid-state battery, elastic layers or similar structures are additionally used, and a certain amount of pressure is required. However, the use of such elastic layers and pressing components leads to a reduction in the energy density of the solid-state battery.

To minimize or prevent volume changes of a solid battery during charging and discharging, it is necessary to suppress the strain generated in the thickness direction of the solid-state battery, and thereby, create a solid-state battery with improved charge-discharge characteristics such as high-rate performance. Moreover, to minimize or prevent volume changes during charging and discharging, it is desirable to eliminate the need for elastic layers and/or pressing members, thereby providing a solid-state battery with enhanced energy density

Hereinafter, a lithium ion conductor according to embodiments and a lithium battery including the same are described in more detail.

A secondary battery according to an embodiment includes an anode-solid electrolyte assembly, wherein the anode-solid electrolyte assembly includes an anode current collector including a plurality of porous protruded portions (i.e., a plurality of protrusion members) and a non-protruded portion between the porous protruded portions, a solid electrolyte including a plurality of uptake rooms, wherein the uptake rooms accommodate the porous protruded portions and are disposed on the anode current collector, and an insulating layer between the non-protruded portion of the anode current collector and the solid electrolyte. Each porous protruded portion includes a metal-containing framework and an interlayer disposed on at least a part of the surface of the porous metal-containing framework.

The porous protruded portions of the anode current collector are accommodated within the uptake rooms of the solid electrolyte layer. As the interlayer is applied onto the porous protruded portions, lithium is deposited during charging of the anode-solid electrolyte assembly in the secondary battery, such as a lithium battery, starting from the region of the porous protruded portion adjacent to the solid electrolyte. Lithium may grow and deposit, for example, toward the center of the uptake room. Lithium may deposit while growing, for example, from the side surfaces of the uptake room toward the center of the uptake room. By growing lithium in a horizontal direction which is perpendicular to the depth direction of the uptake room, i.e., the deposition of the lithium (Li-alloy) from the side surfaces of the uptake room toward the center of the uptake room, the strain acting in the thickness direction of the anode-solid electrolyte assembly may be suppressed.

The volume of the uptake room may be designed to be larger than the volume of lithium supplied from the cathode active material layer, taking into account of the capacity of the cathode. For example, the volume of the uptake room may be designed such that empty space still exists within the uptake room even after charging up to 100% of the State of Charge (SOC). This design may help prevent the occurrence of strain during the lithium deposition process within the uptake room during charging and discharging of the secondary battery, such as a lithium battery.

In a conventional secondary battery, such as a lithium battery, when charging the anode-solid electrolyte assembly, a lithium deposition layer is added between the anode and the solid electrolyte, thereby increasing the volume of the anode-solid electrolyte assembly. Specifically, this volume expansion is predominately in the vertical direction, i.e., in a direction from the anode to the cathode. Moreover, when the thickness of the lithium deposition layer decreases during discharging the anode-solid electrolyte assembly, the volume of the anode-solid electrolyte assembly decreases, thereby increasing the interfacial resistance between the anode and the solid electrolyte. Therefore, the cycle performance of a conventional secondary battery including an anode-solid electrolyte assembly such as a lithium battery, for example, its high-rate performance, may deteriorate.

In contrast, in a secondary battery according to an embodiment of a lithium battery, lithium is deposited within the uptake room during charging and discharging of the anode-solid electrolyte assembly, thereby preventing or minimizing volume change of the assembly due to lithium deposition in the above described vertical direction. Moreover, an associated in an increase in interfacial resistance between the anode and the solid electrolyte due to volume change, as described, of the anode-solid electrolyte assembly may also be prevented or minimized. Since lithium plating/striping (lithiation/delithiation) occur within the uptake room during charging and discharging without any volume change in the anode-solid electrolyte assembly, the reversibility of the electrode reaction is improved. The cycle performance of a secondary battery including the anode-solid electrolyte assembly such as a lithium battery, for example, its high-rate performance may be improved during charging and discharging.

In addition, a secondary battery, for example a lithium battery, including a anode-solid electrolyte assembly according to an embodiment may be operated at normal pressure without additional elastic members and/or pressurizing members because there is no volume change during charging and discharging. Therefore, the energy density of a secondary battery, such as a lithium battery, may be improved. A person of ordinary skill certainly understands that although the above described elastic members may not be necessary in a secondary battery of an embodiment, the secondary battery, or anode-solid electrolyte assembly, described herein may certainly include such structural features or components.

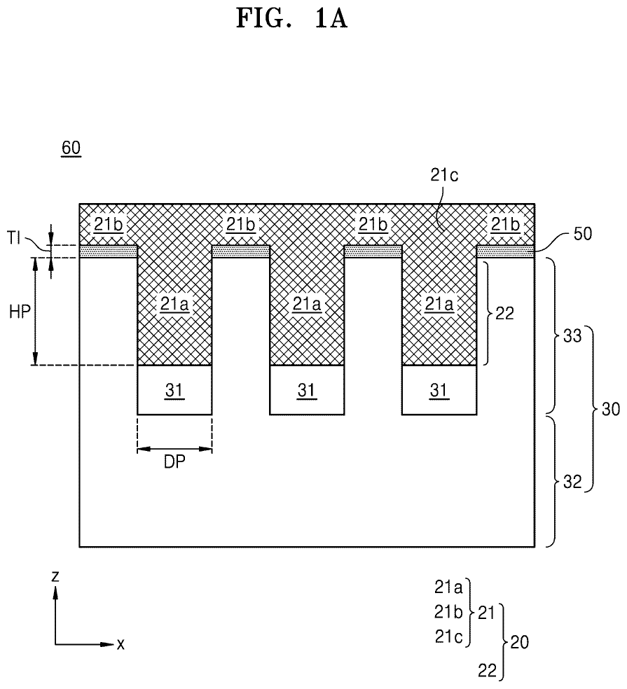

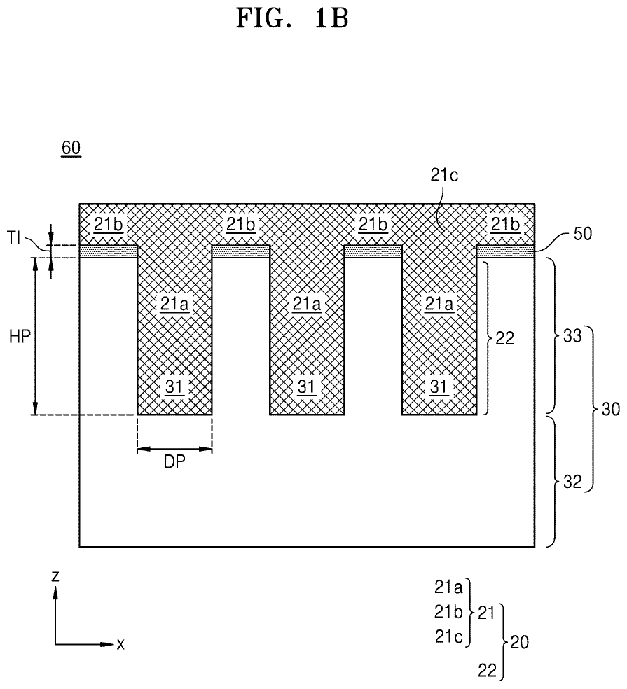

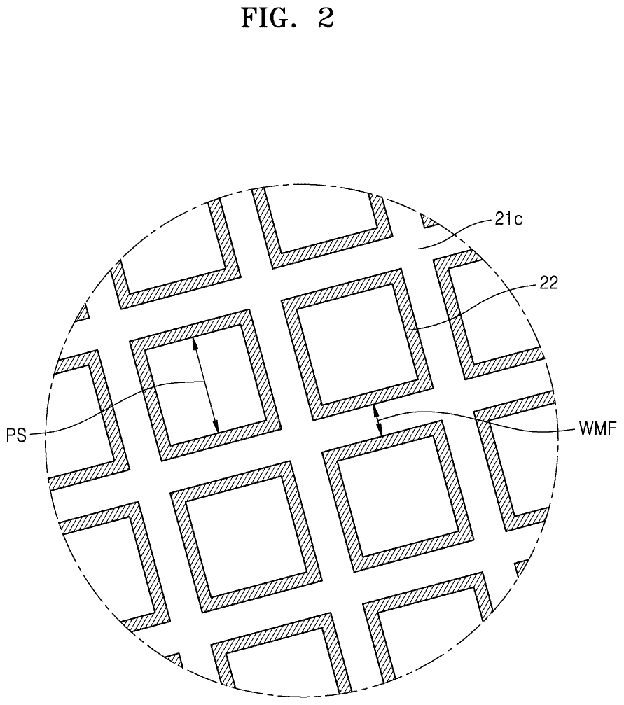

FIGS. 1A and 1B are cross-sectional views of an anode-solid electrolyte assembly included in a secondary battery according to an embodiment. FIG. 2 is a partially enlarged view of a porous protruded portion (i.e., a plurality of protrusion members) in the anode-solid electrolyte assembly of FIGS. 1A and 1B. In some embodiments, the protruded portion is a part of monolithic anode current collector. In some embodiments, the protrusion member is separately disposed on an anode current collector and the protruded portion is a part of composite or non-monolithic anode current collector.

Referring to FIGS. 1A, 1B and 2, the anode-solid electrolyte assembly 60 includes an anode current collector including a plurality of porous protruded portions 21a and non-protruded portions 21b between the porous protruded portions 21a. The anode-solid electrolyte assembly 60 also includes a solid electrolyte 30 including a plurality of uptake rooms 31, the plurality of uptake rooms 31 in accommodation with the plurality of porous protruded portions 21a and being disposed on the anode current collector. The anode-solid electrolyte assembly 60 also includes an insulating layer 50 between the non-protruded portion 21b of the anode current collector and the solid electrolyte 30. As shown in FIG. 2, the porous protruded portion 21a includes a metal-containing framework 21c and an interlayer 22 disposed along the porous metal-containing framework 21c and on at least a portion of the surface of the porous metal-containing framework 21c protruded portion. During charging of the anode-solid electrolyte assembly 60, the porous protruded portion 21a including the interlayer 22 in accommodation with the uptake room 31, allows electrons transmitted by the porous metal-containing framework 21c and lithium ions transmitted through the uptake room 31 of the solid electrolyte 30 to react at the interlayer 22, thereby causing lithium to be deposited. The deposited lithium grows within the interior pores and/or surfaces of the porous protruded portion 21a and in an area proximate to the uptake room 31. For example, the deposited lithium may grow from the side surfaces of the uptake room 31 toward the center of the uptake room 31, and is then stored within the uptake room 31. Since the porous protruded portion 21a is in accommodation with the uptake room 31 and contacts or is proximate to the side surfaces of the uptake room 31, the reversibility of the electrode reaction may be further improved, and therefore, the high-rate performance of a lithium battery 100 including the anode-solid electrolyte assembly 60 may be enhanced.

The deposited lithium is stored in the three-dimensional porous protruded portion 21a, which is coated with the interlayer 22 and positioned within the uptake room 31 of the solid electrolyte 30, thereby preventing strain in the thickness direction caused by the deposited lithium. Also, because an insulating layer 50 is placed between the non-protruded portion 21b of the anode current collector and the solid electrolyte 30, lithium deposition between the two is suppressed, and again, strain in the thickness direction of the anode-solid electrolyte assembly 60 may be minimized or prevented. Because the lithium selectively deposited in the uptake room 31 has a high density, a lithium battery 100 having a high energy density, for example, an energy density of 800 Watt-hours per lite (Wh/L) or more, 900 Wh/L or more, or 1000 Wh/L or more, may be achieved.

Referring to FIGS. 1A, 1B and 2, the porosity of the porous protruded portion 21a may be, for example, 70% or more, 80% or more or 90% or more. The porosity of the porous protruded portion 21a may be 99% or less or 95% or less. The porosity of the porous protruded portion 21a may be, for example, 70% or more and 95% or less or 80% or more and 95% or less. The porosity of the porous protruded portion 21a may be measured, for example, after discharge. The porosity of the porous protruded portion 21a may be, for example, the porosity of the porous protruded portion 21a coated with the interlayer 22. Alternatively, the porosity of the porous protruded portion 21a may be the porosity of the porous protruded portion 21a formed of a porous metal-containing framework 21c excluding the interlayer 22. Because the porous protruded portion 21a has a porosity within this range, strain in the thickness direction of the anode-solid electrolyte assembly 60 may be minimized or more easily prevented.

The porosity (e.g., areal porosity) of the porous protruded portion 21a refers to, for example, the ratio of the area occupied by pores to the total cross-sectional area of the porous protruded portion 21a, and this ratio may be calculated as an areal percentage. The porosity (e.g., areal porosity) of the porous protruded portion 21a may be measured using, for example, a scanning electron microscope (SEM) or a transmission electron microscope (TEM). The porosity of the porous protruded portion 21a may be calculated automatically, for example, using software, or calculated manually.

Referring to FIGS. 1A, 1B and 2, the porous protruded portion 21a includes a porous metal-containing framework 21c, and the porous metal-containing framework 21c may include, for example, copper (Cu), nickel (Ni), stainless steel (SUS), aluminum (Al), indium (In), magnesium (Mg), titanium (Ti), iron (Fe), cobalt (Co), nickel (Ni), zinc (Zn), germanium (Ge) or a combination thereof. The inclusion of such metals in the porous metal-containing framework 21c provides high electronic conductivity and ductility, allowing the porous protruded portion 21a to accommodate volume changes during charging and discharging more easily. The content of the metal described above in the porous metal-containing framework 21c may be, for example, 90 wt % or more, 95 wt % or more, or 99 wt % or more of the total weight of the porous metal-containing framework 21c. The porous metal-containing framework 21c may be, for example, a substantially porous metal framework.

Alternatively, the porous protruded portion 21a may include a porous metal-containing framework 21c, and the porous metal-containing framework 21c may include, for example, a porous conductive ceramic-containing framework. The inclusion of such a porous conductive ceramic-containing framework in the porous protruded portion 21a may provide excellent electronic conductivity and improved structural stability. The porous conductive ceramic-containing framework may include, for example, a metal oxide, a metal nitride, a metal nitride, a metal carbide, or a combination thereof.

Conductive metal oxides may include, for example, platinum oxide (PtO), iridium oxide (IrO₂), ruthenium oxide (RuO₂), strontium ruthenium oxide (SrRuO₃), barium strontium ruthenium oxide ((Ba,Sr)RuO₃), calcium ruthenium oxide (CaRuO₃), lanthanum strontium cobalt oxide ((La,Sr)CoO₃), and the like. Conductive metal nitrides may include, for example, titanium nitride (TiN), tantalum nitride (TaN), niobium nitride (NbN), molybdenum nitride (MoN), cobalt nitride (CoN), tungsten nitride (WN), and the like. Conductive metal oxynitrides may include, for example, titanium oxynitride (TiON), zinc oxynitride (ZnOₓN_{y}), tantalum oxynitride (TaON), and the like. Conductive metal carbides may include, for example, titanium carbide (TiC), iron carbide (Fe₃C), tungsten carbide (WC), and the like.

Referring to FIGS. 1, 1B and 2, the porous protruded portion 21a may include, for example, open pores. Open pores refer to pores that are connected to adjacent pores and are connected to the surface of the porous protruded portion 21a. Closed pores refer to pores that are isolated from adjacent pores by the metal framework. The presence of open pores in the porous protruded portion 21a allows lithium ions to more easily migrate into the interior of the porous protruded portion 21a along the surface of the porous framework. This enhances the reversibility of the electrode reaction in the porous protruded portion 21a. The porous protruded portion 21a may include pores with sizes greater than the width of the frames constituting the porous metal-containing framework 21c.

The ratio (PS/WMF) of the pore size (PS) included in the porous protruded portion 21a to the width of the metal frame (WMF) may be 1.5 or more, 2 or more, 3 or more, or 5 or more. The pore size and the width of the metal frame included in the porous protruded portion 21a may be measured, for example, from scanning electron microscope images or transmission electron microscope images of a cross-section of the porous protruded portion 21a. When the PS/WMF ratio of the pore size to the width of the metal frame included in the porous protruded portion 21a falls within these values, the porous protruded portion 21a may exhibit increased porosity, and therefore, the volume or amount of lithium stored within the porous protruded portion 21a may increase. The energy density of a lithium battery 100 including the anode-solid electrolyte assembly 60 may be improved.

The porous protruded portion 21a may include pores, and the pore size (PS) may be, for example, about 0.1 micrometer (μm) to about 200 μm, about 1 μm to about 100 μm, about 1 μm to about 50 μm or about 1 μm to about 10 μm. Because the porous protruded portion 21a has a pore size within this range, lithium deposited within the porous protruded portion 21a may be more easily accommodated. The width of the metal frame (WMF) constituting the porous metal-containing framework 21c may be, for example, about 0.1 μm to about 100 μm, about 1 μm to about 50 μm, about 1 μm to about 25 μm or about 1 μm to about 5 μm. Because the width of the metal frame constituting the porous metal-containing framework 21c is within this range, the change in volume of the porous metal-containing framework 21c during charging and discharging may be accommodated more easily and with less structural stress.

Referring to FIGS. 1A and 1B, the height (HP) of the porous protruded portion 21a is greater than the thickness (TI) of the insulating layer 50. The ratio (HP/TI) of the height (HP) of the porous protruded portion 21a to the thickness (TI) of the insulating layer 50 may be, for example, 2 or more, 5 or more, or 10 or more. The ratio (HP/TI) of the height (HP) of the porous protruded portion 21a to the thickness (TI) of the insulating layer 50 may be, for example, about 2 to 1000, about 5 to 1000, or about 10 to 1000. Because the ratio (HP/TI) of the height (HP) of the porous protruded portion 21a and the thickness (TI) of the insulating layer 50 is within this range, a decrease in energy density due to a high thickness of the insulating layer 50 may be minimized or prevented, and sufficient space may be secured to store lithium deposited within the porous protruded portion 21a.

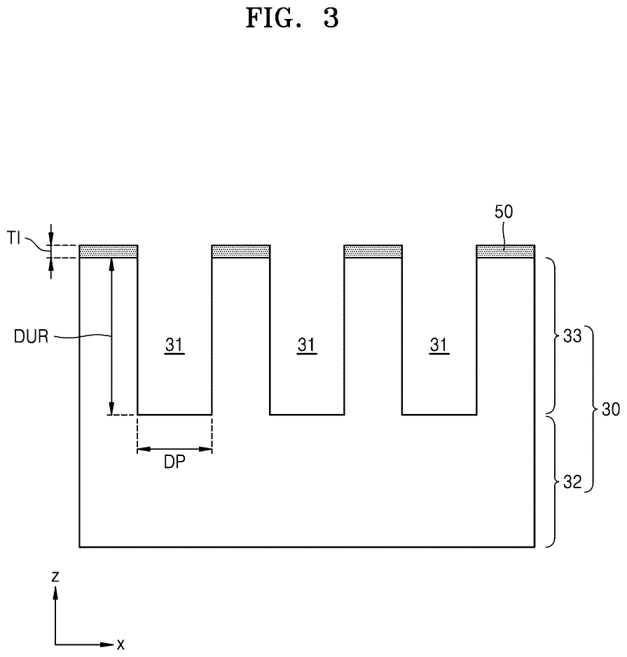

FIG. 3 is a cross-sectional view of a solid electrolyte 30 with an insulating layer 50 introduced on an outermost surface according to an embodiment.

Referring to FIG. 1A, FIG. 1B and FIG. 3, the depth of the uptake room 31 (DUR) is greater than the thickness (TI) of the insulating layer 50. The ratio (DUR/TI) of the depth of the uptake room 31 (DUR) and the thickness of the insulation layer 50 (TI) may be, for example, 5 or more, 10 or more, 20 or more, or 50 or more. The ratio (DUR/TI) of the depth of the uptake room 31 (DUR) and the thickness of the insulation layer 50 (TI) may be, for example, about 5 to 1000, about 10 to 1000, about 20 to 1000, or about 50 to about 1000. Because the ratio (DUR/TI) of the depth of the uptake room 31 (DUR) and the thickness of the insulation layer 50 (TI) has this range, the reduction in energy density due to the high thickness of the insulation layer 50 may be minimized or prevented, and sufficient space may be secured to store lithium deposited within the uptake room 31.

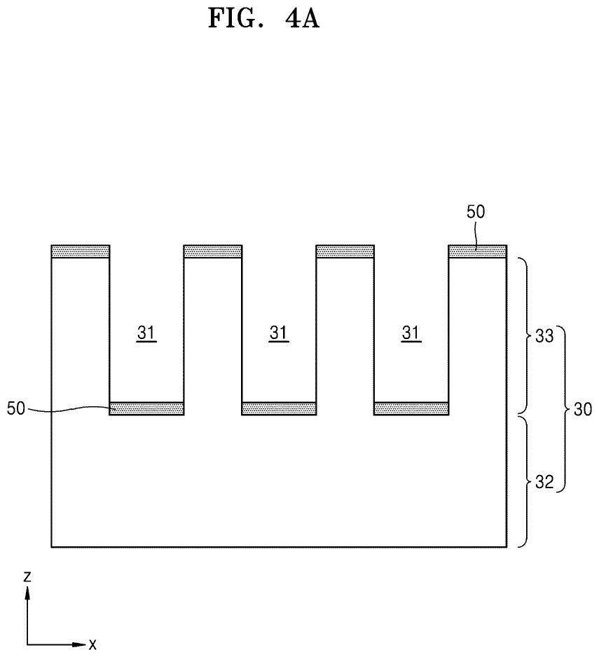

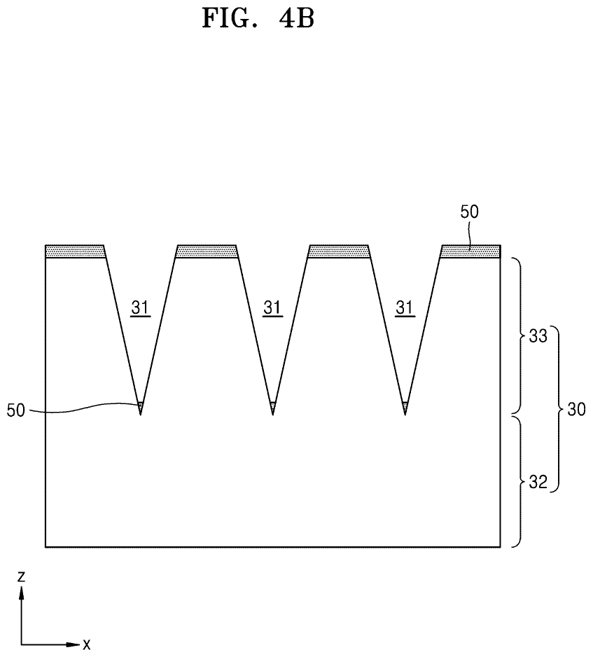

FIGS. 4A and 4B are cross-sectional views of a solid electrolyte 30 in which an insulating layer 50 is disposed on an outermost (upper) surface and at a lower surface (or floor) of the uptake room according to one embodiment.

Referring to FIGS. 1A, 1B, 4A, and 4B, when the solid electrolyte 30 of FIG. 4A or 4B is applied to the anode-solid electrolyte assembly 60 of FIG. 1A or 1B, the anode-solid electrolyte assembly 60 may further include an insulating layer 50 disposed on the bottom (floor) of the uptake room 31. By further including an insulating layer 50 disposed on the bottom of the uptake room 31, lithium deposition may be prevented at or near the bottom of the uptake room 31 in the anode-solid electrolyte assembly 60. Accordingly, lithium deposited from the bottom of the uptake room 31 grows in the thickness direction, thereby more effectively preventing the occurrence of strain in the thickness direction of the anode-solid electrolyte assembly 60.

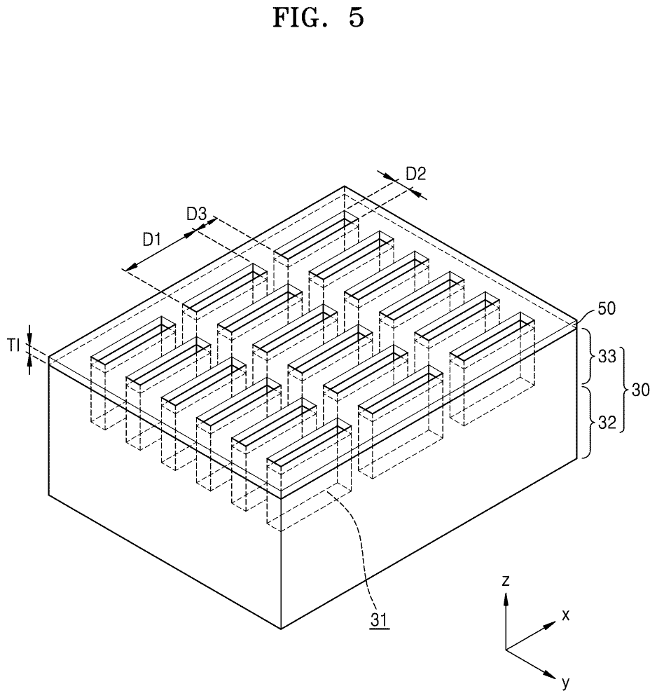

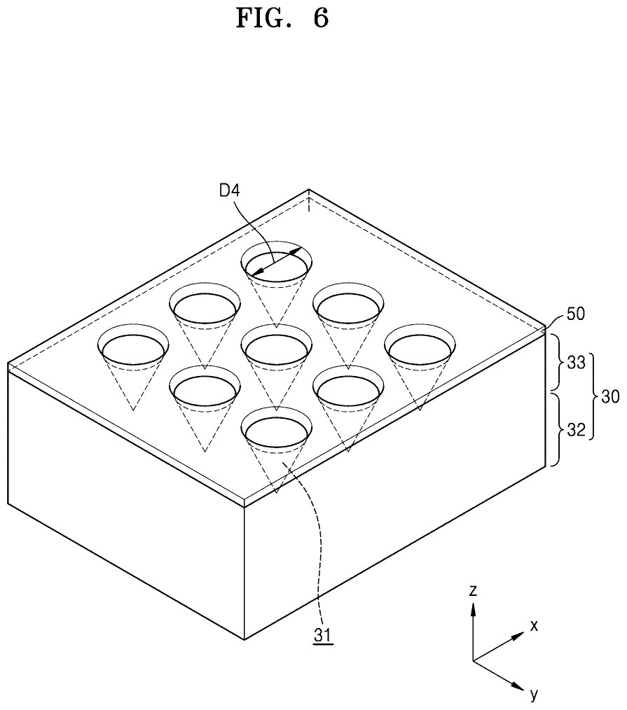

FIG. 5 is a schematic view of a solid electrolyte including a plurality of uptake rooms having rectangular openings or volume according to an embodiment. FIG. 6 is a schematic view of a solid electrolyte including a plurality of uptake rooms having circular openings and a conical volume according to an embodiment. Of course, another embodiment of a solid electrolyte may include a plurality of uptake rooms having circular openings and a cylindrical volume. In fact, the uptake rooms can take on any volumetric shape.

When a porous anode current collector is placed on a solid electrolyte 30 including a plurality of uptake rooms 31 and pressure is applied in the thickness direction, the porous anode current collector facing the plurality of uptake rooms 31 is accommodated within the plurality of uptake rooms 31 to form a porous protruded portion 21a. In this process, the shape of the area adjacent to the opening of the uptake room of the porous protruded portion 21a may be determined by the shape of the opening of the uptake room 31. Referring to FIGS. 5 and 6, the opening of the uptake room 31 of the solid electrolyte 30 may have, for example, a circular, oval or polygonal shape. The porous protruded portion 21a may have a circular, elliptical or polygonal cross-sectional shape when viewed in the thickness direction (z direction) in the area adjacent to the opening of the uptake rooms 31. Polygons include, but are not limited to, triangles, rectangles, squares, pentagons, hexagons, octagons, etc. Since the porous protruded portion 21a has a certain cross-sectional shape in the area adjacent to the opening of the uptake rooms, the porous protruded portion 21a may have a three-dimensional structure extending from this cross-sectional shape. Since the plurality of porous protruded portions 21a have a uniform three-dimensional structure, uniform lithium deposition may be induced from the plurality of porous protruded portions 21a. It is possible to prevent the occurrence of strain in the thickness direction (z direction) due to non-uniform lithium deposition in the anode-solid electrolyte assembly 60.

Referring to FIG. 5, the opening of the uptake rooms 31 of the solid electrolyte 30 may have, for example, a rectangular shape. The length of the major axis of the rectangular opening (D1) is, for example, about 0.1 μm to about 200 μm, about 0.1 μm to about 50 μm, about 0.1 μm to about 10 μm, or about 1 μm to about 5 μm. The width (D2) of the short axis of the rectangular opening (D1) is, for example, about 0.1 μm to about 100 μm, about 0.1 μm to about 20 μm, about 0.1 μm to about 50 μm, or about 0.1 μm to about 1 μm. The spacing (D3) between adjacent openings (in the D1 direction) is, for example, about 0.1 μm to about 100 μm, about 0.1 μm to about 20 μm, about 0.1 μm to about 50 μm, or about 0.1 μm to about 1 μm.

Referring to FIG. 6, the opening of the uptake rooms 31 of the solid electrolyte 30 may have a circular shape, for example. The diameter of the circular opening (D4) is, for example, about 0.1 μm to about 200 μm, about 0.1 μm to about 50 μm, about 0.1 μm to about 10 μm, or about 1 μm to about μm.

Referring to FIGS. 1A and 1B, the height of the porous protruded portion 21a is, for example, about 1 μm to about 500 μm, about 1 μm to about 100 μm, about 1 μm to about 50 μm, about 1 μm to 10 μm or 1 to 5 μm. The length of the porous protruded portion 21a is, for example, about 0.1 μm to about 200 μm, about 0.1 μm to about 50 μm, about 0.1 μm to about 10 μm, or about 1 μm to about 5 μm. When the cross-section of the porous protruded portion 21a is in the shape of an ellipse or polyhedron, the diameter of the porous protruded portion 21a is the arithmetic mean of the maximum and minimum values of the diameter. By having a height and diameter within this range, the porous protruded portion 21a may more effectively accommodate volume changes during charging and discharging.

Referring to FIGS. 1A and 1B, the porous protruded portion 21a may have an average diameter and maximum height aspect ratio of 1 or more, 2 or more, 5 or more, 10 or more, or 20 or more. The maximum height of the porous protruded portion 21a is the maximum value of the height of the porous protruded portion 21a (HP). As indicated in FIG. 1B, the average width (DP) of the porous protruded portion 21a is about half of the height of the porous protruded portion 21a (HP). The height of the porous protruded portion 21a and the width of the porous protruded portion 21a may be measured from a scanning electron microscope (SEM) or transmission electron microscope (TEM) image of a cross-section of the porous protruded portion 21a. Because the porous protruded portion 21a has an aspect ratio within this range, the area of the porous protruded portion 21a facing the side surfaces of the uptake rooms 31 may be increased. The lithium ions initially deposit along the side surfaces of the uptake rooms 31 may be more effectively accommodated within the porous protruded portion 21a. The reversibility of the electrode reaction may be further improved.

Alternatively, although not shown in the drawing, the porous protruded portion 21a may have an aspect ratio of width (DP) to height (HP) of less than 1. Since the porous protruded portion 21a has an aspect ratio in this range, the distance between the two side surfaces of the porous protruded portion 21a may be increased compared to the thickness of the porous protruded portion 21a. Lithium deposited on the porous protruded portion 21a may be stored more easily along the horizontal direction of the porous protruded portion 21a. Because lithium deposited in the thickness direction (z-direction) of the anode-solid electrolyte assembly 60 is reduced, thickness-direction strain caused by the deposited lithium may be suppressed.

Referring to FIGS. 1A, 1B to 6, the porous protruded portion 21a may include, for example, a plate shape, a rod shape, a cone shape, a pyramid shape, or a combination thereof. By having such shapes, the porous protruded portion 21a may stably accommodate changes in volume during charging and discharging, and prevent issues such as electrical disconnection due to breakage of the porous protruded portion 21a during repeated charging and discharging processes. For example, if the porous protruded portion 21a has an hourglass shape, the center of the protruded portion 21a may be cut off during the charging and discharging process, potentially resulting in a reduction of discharge capacity by half.

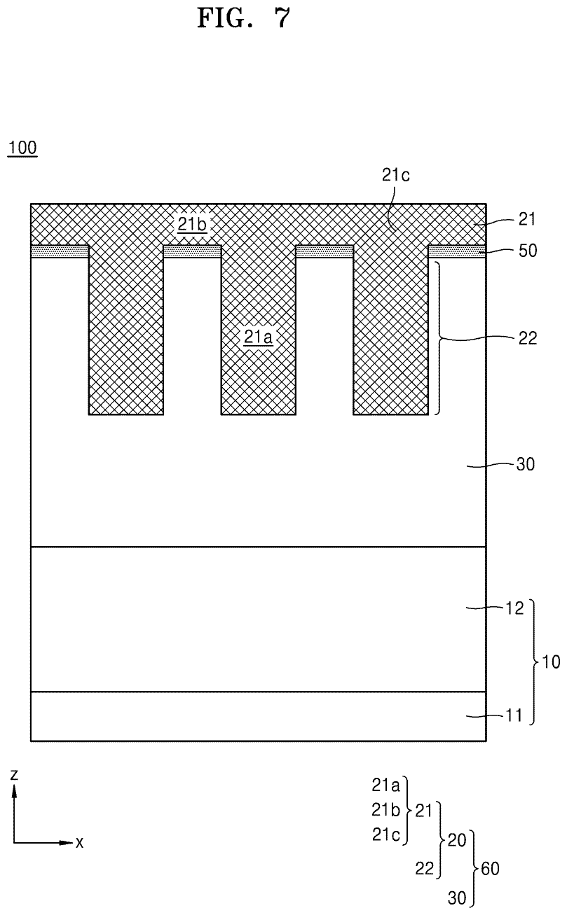

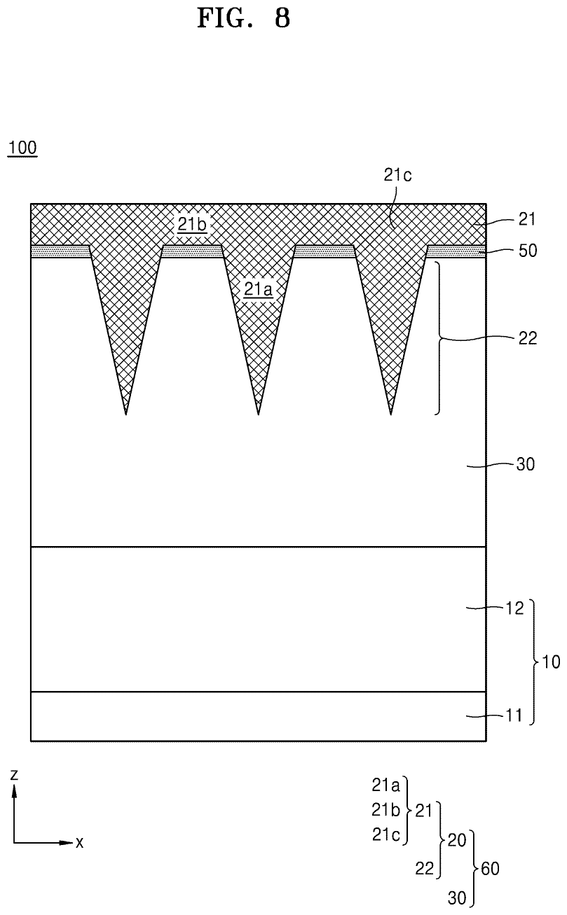

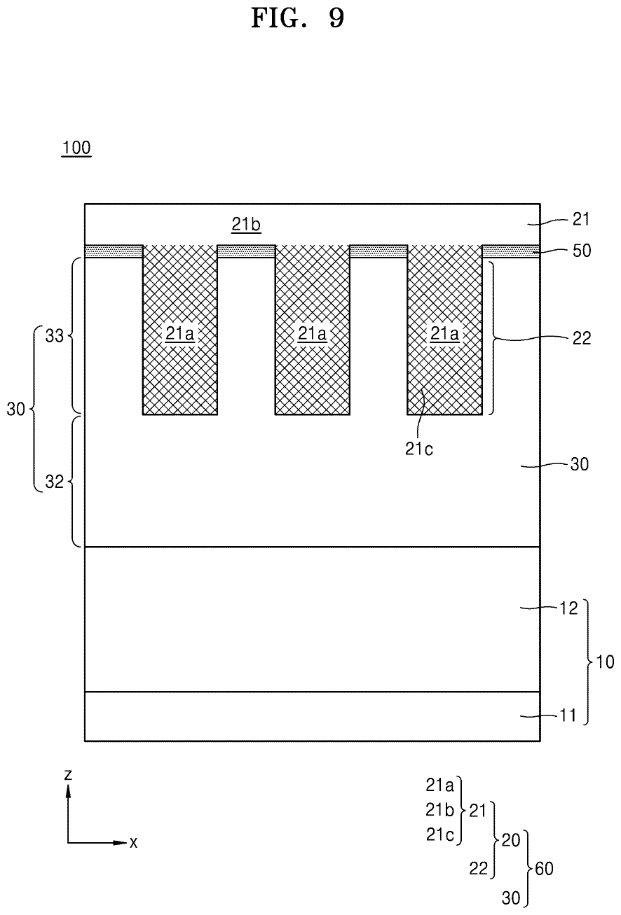

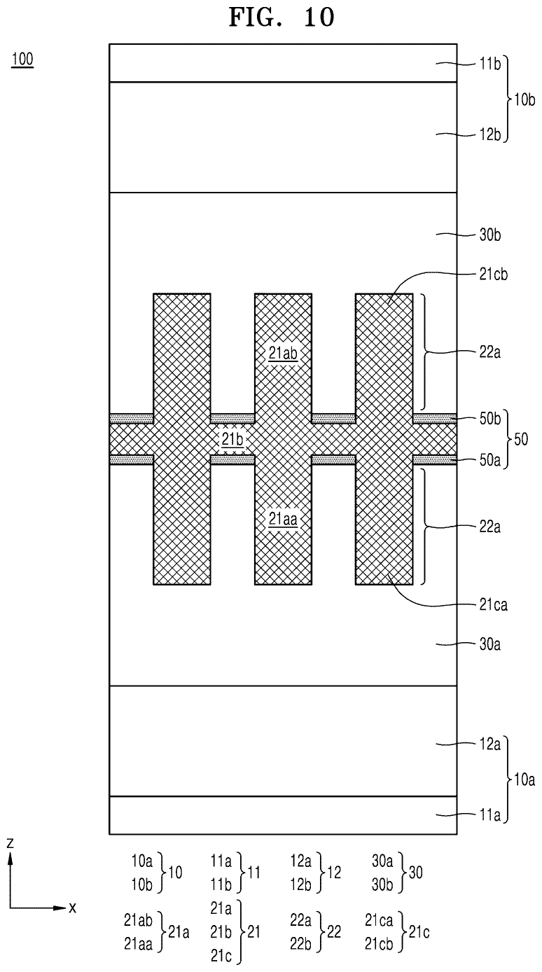

FIG. 7 is a schematic view of a secondary battery including an anode-solid electrolyte assembly according to an embodiment. FIG. 8 is a schematic view of a secondary battery including an anode-solid electrolyte assembly according to an embodiment. FIG. 9 is a schematic view of a secondary battery including an anode-solid electrolyte assembly according to an embodiment. FIG. 10 is a schematic view of a secondary battery including an anode-solid electrolyte assembly according to an embodiment. The secondary battery may be, for example, a lithium battery 100.

Referring to FIGS. 7 to 10, the side contour of the porous protruded portion 21a is defined by the side contour of the uptake room 31. The side contour of the porous protruded portion 21a may be arranged to match the side contour of the uptake room 31. The side surface of the porous protruded portion 21a may be in contact with the side surface of the uptake rooms 31. The side contour of the porous protruded portion 21a may be arranged to conform to and contact the side contour of the uptake room 31. Because the side contour of the porous protruded portion 21a is arranged along the side contour of the uptake room 31, lithium deposition may be more easily induced in the porous protruded portion 21a by the transfer of lithium ions from the side surfaces of the uptake room 31. The reversibility of electrode reactions may be improved. High-rate performance may be improved in a lithium battery 100 including an anode-solid electrolyte assembly 60.

Referring to FIG. 1A and FIGS. 7 to 10, the porous protruded portion 21a may extend, for example, to the bottom surface of the uptake room 31.

As the porous protruded portion 21a extends to the bottom surface of the uptake room 31 the area where lithium ions may be transferred from the side surfaces of the uptake room 31 to the porous protruded portion 21a may be further expanded. Therefore, the high-rate performance of the lithium battery 100 may be further improved.

Referring to FIG. 1B, the porous protruded portion 21a may be spaced apart from the bottom surface of the uptake room 31.

By the porous protruded portion 21a being spaced apart from the bottom surface of the uptake room 31, lithium deposition may be prevented from the bottom surface of the uptake room 31. By preventing lithium deposition from the bottom surface of the uptake room 31, the occurrence of strain in the thickness direction (z direction) due to lithium deposited from the bottom surface of the uptake room 31 may be prevented. The ratio (HP/DUR) of the height of the porous protruded portion 21a (HP) to the depth of the uptake room (DUR) is, for example, 0.9 or less, 0.8 or less, or 0.7 or less. See, FIG. 3 for the DUR dimension. By having the ratio (HP/DUR) of the height of the porous protruded portion 21a (HP) and the depth of the uptake room (DUR) within this range, lithium deposition may be prevented from the bottom surface of the uptake room 31.

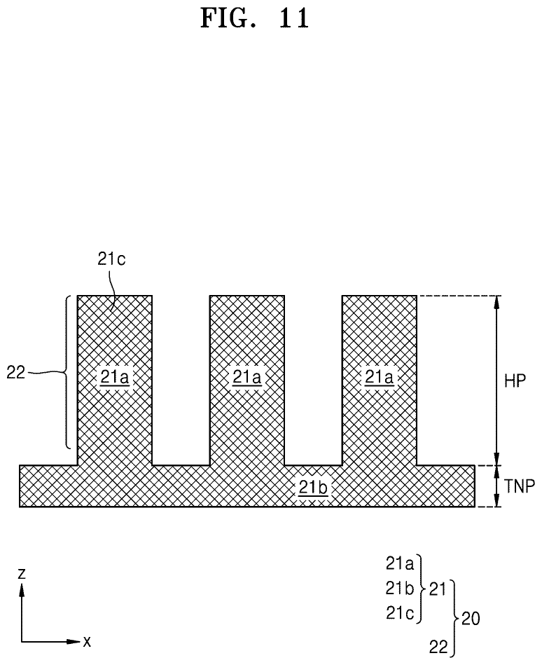

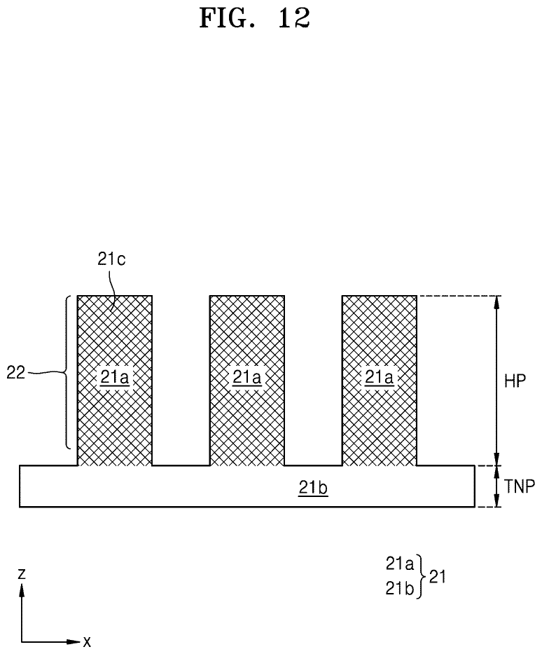

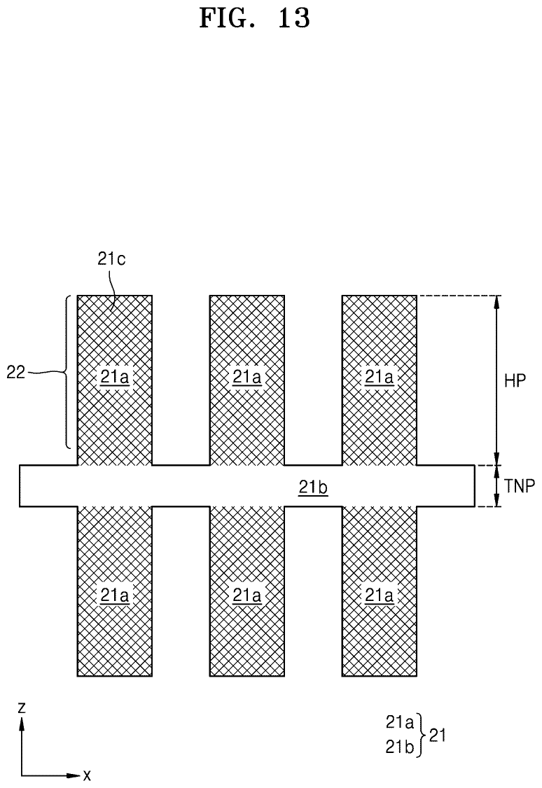

FIG. 11 is a cross-sectional view of an anode current collector including protruded portions 21a and a non-protruded portion 21b according to an embodiment. FIG. 12 is a cross-sectional view of an anode current collector including protruded portions 21a and a non-protruded portion 21b according to another embodiment. FIG. 13 is a cross-sectional view of an anode current collector including protruded portions 21a and non-protruded portion 21b in another embodiment. Referring to FIGS. 1A, 1B, and 7 to 12, the height of the porous protruded portion 21a (HP) in the anode current collector is greater than the thickness of the non-protruded portion 21b (TNP). Because the height of the porous protruded portion 21a (HP) is greater than the thickness of the non-protruded portion 21b (TNP), the thickness of the anode-solid electrolyte assembly 60 increased by the anode current collector may be suppressed. If the thickness of the non-protruded portion 21b (TNP) becomes too thick, the energy density of the lithium battery 100 including the anode-solid electrolyte assembly 60 may decrease.

The ratio (HP/TNP) of the height of the porous protruded portion 21a (HP) and the thickness of the non-protruded portion 21b (TNP) may be 2 or more, 5 or more, 10 or more, or 20 or more. By having the ratio (HP/TNP) of the height of the porous protruded portion 21a (HP) and the thickness of the non-protruded portion 21b (TNP) within this range, the energy density of the lithium battery 100 may be increased while suppressing an increase in the volume of the lithium battery 100. The thickness of the non-protruded portion 21b may be, for example, about 1 μm to about 100 μm, about 1 μm to about 50 μm, about 1 μm to about 10 μm, about 1 μm to about 5 μm or about 1 μm to about 2 μm.

Referring to FIGS. 1A, 1B, 7 to 11, the non-protruded portion 21b of the anode current collector may be porous. Due to the porosity of the non-protruded portion 21b of the anode current collector, the energy density per unit weight of the lithium battery 100 may be improved.

Since the non-protruded portion 21b of the anode current collector is porous, the non-protruded portion 21b may function as a buffer layer that alleviates volume changes of the protruded portion. The non-protruded portion 21b and the protruded portions 21a may have a monolithic structure formed integrally. Alternatively, the protruded portions 21a may be added separately on the non-protruded portion 21b. The porosity of the non-protruded portion 21b (PNP) is, for example, less than the porosity of the protruded portions (PP). The ratio (PNP/PP) of the porosity of the non-protruded portion 21b (PNP) to the porosity of the protruded portions (PP) may be, for example, 0.8 or less, 0.7 or less, 0.5 or less, or 0.3 or less. During the process of pressing the laminate of the anode current collector and the solid electrolyte 30 in the thickness direction, the non-protruded portion 21b is compressed, so the porosity of the non-protruded portion 21b may be lowered compared to the porosity of the protruded portions. Due to the lower porosity of the non-protruded portion 21b compared to the protruded portions, the structural stability of the anode current collector may be improved. The porosity of the non-protruded portion 21b is, for example, defined as the ratio of the area occupied by pores to the total area of the cross-section of the non-protruded portion 21b, and the ratio may be calculated as a percentage. The porosity of the porous protruded portion 21a may also be calculated in the same manner. The porosity may be measured using, for example, scanning electron microscopy (SEM) and transmission electron microscopy (TEM). The porosity may be calculated automatically, for example using software, or manually.

Referring to FIGS. 12 and 13, the non-protruded portion 21b in the anode current collector is non-porous. Because the non-protruded portion 21b of the anode current collector is nonporous, the energy density per unit volume of the lithium battery 100 may be improved. The structural stability of the anode current collector may be improved by the non-protruded portion 21b of the anode current collector being nonporous. The non-protruded portion 21b of the anode current collector may be, for example, a metal sheet, a metal foil, a conductive ceramic sheet, or a conductive ceramic film.

Referring to FIGS. 1A, 1B, 7 to 13, a plurality of porous protruded portions 21a are arranged periodically or regularly spaced apart from each other. A plurality of porous protruded portions 21a are periodically arranged at regular intervals on the surface of the anode current collector. A plurality of porous protruded portions 21a are arranged at regular intervals on the surface of the anode current collector. A plurality of porous protruded portions 21a are spaced apart and arranged in a patterned array on the surface of the anode current collector. By arranging a plurality of porous protruded portions 21a spaced apart in this manner, the uniformity of electrode reaction in a lithium battery 100 including an anode-solid electrolyte assembly 60 may be improved. Accordingly, strain in the thickness direction (z direction) of the lithium battery 100 due to local deposition of lithium may be prevented. By arranging the plurality of porous protruded portions 21a spaced apart in this manner, it is distinguished from the conventional anode current collector in which the plurality of porous protruded portions 21a are arranged irregularly, non-periodically, or in a non-pattern.

Referring to FIG. 10 and FIG. 13, a plurality of porous protruded portions 21a are arranged on both sides of the anode current collector. The energy density of a lithium battery 100 may be improved by arranging porous protruded portions 21a on both sides of the anode current collector. Because porous protruded portions 21a are arranged on both surfaces of the anode current collector, the volume change of the porous protruded portions 21a progresses symmetrically during the charging and discharging process of the lithium battery 100, so that the occurrence of asymmetric stress due to asymmetric volume change may be prevented or minimized. The structural stability of the lithium battery 100 may be improved during the charging and discharging process of the lithium battery 100.

Referring to FIG. 10, an anode-solid electrolyte assembly 60 includes a solid electrolyte 30, and the solid electrolyte 30 includes a first solid electrolyte 30a disposed on one surface of an anode current collector and a second solid electrolyte 30b disposed on the other surface opposite to one surface of the anode current collector. The anode-solid electrolyte assembly 60 may have a symmetrical structure of first solid electrolyte 30a/anode current collector 21/second solid electrolyte 30b. Because the anode-solid electrolyte assembly 60 has such a symmetrical structure, the structural stability of the anode-solid electrolyte assembly 60 may be improved during charging and discharging.

Referring to FIGS. 1A to 11, the insulating layer 50 may be, for example, an inorganic insulating layer. The insulating layer 50 may be deposited on the surface of the solid electrolyte 30 by, for example, sputtering, CVD, PVD, etc. The inorganic insulating layer includes, for example, an insulating metal oxide. Metal oxides include, for example, aluminum oxide (Al₂O₃), titanium dioxide (TiO₂), zirconium oxide (ZrO₂), tin dioxide (SnO₂), zinc oxide (ZnO), silicon dioxide (SiO₂), niobium oxide (Nb₂O₅), tantalum oxide (Ta₂O₅), or a combination thereof. Because the anode-solid electrolyte assembly 60 includes an insulating layer 50 between the non-protruded portion 21b of the anode current collector and the solid electrolyte 30, lithium deposition between the non-protruded portion 21b of the anode current collector and the solid electrolyte 30 may be prevented or minimized. The thickness of the insulating layer 50 may be, for example, about 10 nm to about 10 μm, about 10 nm to about 1 μm, about 10 nm to about 500 nm, about 1 nm to about 100 nm or about 1 nm to about 20 nm. Because the insulating layer 50 has a thickness in this range, lithium deposition between the non-protruded portion 21b of the anode current collector and the solid electrolyte 30 may be effectively prevented without substantial reduction in energy density.

Referring to FIGS. 1A, 1B and 7 to 11, the anode-solid electrolyte assembly 60 may include an interlayer 22. The interlayer 22 is arranged along the surface of the porous metal framework 21c on the porous protruded portion 21a. The interlayer 22 may be, for example, a mixed conductive layer having ionic and electronic conductivity. The interlayer 22 includes an interlayer forming material having an ionic conductivity of 10⁻⁸ S/cm or higher, for example, about 10⁻⁸ S/cm to about 10⁸ S/cm, and an electronic conductivity of 4.0×10⁻⁹ S/cm or higher, for example, about 4.0×10⁻⁹ S/cm to about 10⁸ S/cm. As used herein, the “interlayer forming material” provides both ionic conductivity and electronic conductivity. The electronic conductivity of the interlayer forming material is, for example, at 25° C., 4.0×10⁻⁹ S/cm or more, 1.0×10⁻⁸ S/cm or more, 4.0×10⁻⁸ S/cm or more, 1.0×10⁻⁷ S/cm or more, 4.0×10⁻⁷ S/cm or more, 1.0×10⁻⁶ S/cm or more, or 1.0×10⁻⁵ S/cm or more. Because the interlayer forming material has such high electronic conductivity, the internal resistance of a lithium battery 100 including the interlayer forming material may be reduced. The ionic conductivity of the interlayer forming material is, for example, 1.0×10⁻⁸ S/cm or more, 1.0×10⁻⁶ S/cm or more, 5.0×10⁻⁶ S/cm or more, 1.0×10⁻⁵ S/cm or more, or 5.0×10⁻⁵ S/cm or more. In another embodiment, the ionic conductivity of the interlayer forming material is, for example, 1.0×10⁻⁸ S/cm to 10⁸ S/cm. Because the interlayer forming material has such high electronic conductivity, the internal resistance of a lithium battery 100 including the interlayer forming material may be reduced.

The interlayer 22 may include, for example, a carbon-based anode active material or a combination of a carbon-based anode active material and a metal-based anode active material. A binder may be added to the interlayer 22.

The interlayer 22 may include, for example, a carbon-based material or a combination of a carbon-based material and a metal-based material. The interlayer 22 may include, for example, lithium. The carbon-based material may include, for example, amorphous carbon. The metal-based material may include, for example, indium (In), silicon (Si), gallium (Ga), tin (Sn), aluminum (Al), titanium (Ti), zirconium (Zr), niobium (Nb), germanium (Ge), antimony (Sb), bismuth (Bi), gold (Au), platinum (Pt), palladium (Pd), magnesium (Mg), silver (Ag), zinc (Zn), nickel, iron, cobalt, chromium, cesium, sodium, potassium, calcium, yttrium, bismuth, tantalum, hafnium, barium, vanadium, strontium, lanthanum or a combination thereof. Amorphous carbon may include, for example, carbon black (CB), acetylene black (AB), furnace black (FB), ketjen black (KB), graphene, carbon nanotubes, carbon nanofibers, or the like.

The interlayer 22 may include a composite of first particles made of amorphous carbon and second particles made of a metal-based material or may include a mixture of first particles made of amorphous carbon and second particles made of a metal-based material. In the composite of the first particles and the second particles and/or the mixture of the first particles and the second particles, the mixing weight ratio of the first particles and the second particles is, for example, about 10:1 to about 1:2, about 5:1 to about 1:1, or about 4:1 to about 2:1. The mixture of the first particles and the second particles is a simple mixed result of the first particles and the second particles or a mixed result physically bound by a binder.

The content of the second particles is about 1 wt % to about 60 wt %, about 8 wt % to about 60 wt %, about 10 wt % to about 50 wt %, about 15 wt % to about 40 wt %, or about 20 wt % to about 30 wt %, based on the total weight of the composite of the first particles and the second particles or the mixture of the first particles and the second particles. By having the second particles content in this range, the cycle performance of, for example, a lithium battery 100 may be further improved.

The interlayer 22 may include, for example, lithium; a carbon-based material capable of reacting with lithium; a mixture of a carbon-based material and a metal-based material; a composite of a carbon-based material and a metal-based material; or a combination thereof. The carbon-based material may include, for example, amorphous carbon. The metal-based material may include, for example, one or more selected from indium (In), silicon (Si), gallium (Ga), tin (Sn), aluminum (Al), titanium (Ti), zirconium (Zr), niobium (Nb), germanium (Ge), antimony (Sb), bismuth (Bi), gold (Au), platinum (Pt), palladium (Pd), magnesium (Mg), silver (Ag), and zinc (Zn). The interlayer 22 may, for example, contain only amorphous carbon. The interlayer 22 may include, for example, amorphous carbon and one or more metal-based materials selected from indium (In), silicon (Si), gallium (Ga), tin (Sn), aluminum (Al), titanium (Ti), zirconium (Zr), niobium (Nb), germanium (Ge), antimony (Sb), bismuth (Bi), gold (Au), platinum (Pt), palladium (Pd), magnesium (Mg), silver (Ag), and zinc (Zn). The interlayer 22 may include, for example, a complex of amorphous carbon and one or more metal-based materials selected from, for example, indium (In), silicon (Si), gallium (Ga), tin (Sn), aluminum (Al), titanium (Ti), zirconium (Zr), niobium (Nb), germanium (Ge), antimony (Sb), bismuth (Bi), gold (Au), platinum (Pt), palladium (Pd), magnesium (Mg), silver (Ag), and zinc (Zn). The interlayer 22 may include, for example, a mixture of amorphous carbon and silver (Ag). The mixing ratio of amorphous carbon and silver (Ag) may be, for example, about 10:1 to about 1:2, about 5:1 to about 1:1, or about 4:1 to about 2:1 in weight ratio.

The interlayer 22 may include, for example, a complex of amorphous carbon and silver (Ag). The composite ratio of amorphous carbon and silver (Ag) may be, for example, about 10:1 to about 1:2, about 5:1 to about 1:1, or about 4:1 to about 2:1 in weight ratio. The interlayer 22 may include, for example, a carbon-based material such as amorphous carbon; a metal-based material such as graphite, gold, silver, nickel, platinum, molybdenum, tungsten, stainless steel, lithium-Ag; a carbon-metal composite such as carbon-Ag; or a combination thereof.

The thickness of the interlayer 22 is, for example, 10 μm or less, 5 μm or less, 3 μm or less, or 1 μm or less. The thickness of the interlayer 22 is, for example, about 0.01 μm to about 10 μm, about 0.1 μm to about 5 μm, about 0.1 μm to about 3 μm, or about 0.1 μm to about 1 μm. Because the interlayer 22 has a thickness within this range, the reversibility of the electrode reaction may be further enhanced. The energy density of a lithium battery 100 may be improved and its high-rate performance may be enhanced. The thickness of the interlayer 22 may be, for example, the thickness of the cross-section coated in the vertical direction from the surface of the porous metal-containing framework 21c of the interlayer 22 applied onto the porous metal-containing framework 21c.

The interlayer 22 may be applied onto, for example, 10% or more, 30% or more, or 50% or more of the total surface area of the porous metal-containing framework 21c constituting the porous protruded portion 21a. The interlayer 22 may be applied onto, for example, about 10% to about 100%, about 30% to about 90% or about 50% to about 90% of the total surface area of the porous metal-containing framework 21c constituting the porous protruded portion 21a. The reversibility of the electrode reaction may be further improved by applying the interlayer 22 within this range. The area of the porous metal-containing framework 21c coated with the interlayer 22 may be determined, for example, from a scanning electron microscope image or transmission electron microscope image of a cross-section of the porous protruded portion 21a.

The anode-solid electrolyte assembly 60 may further include lithium metal, lithium alloy, or a combination thereof accommodated in at least a portion of the uptake room 31. Lithium metal, lithium alloy or a combination thereof may be disposed on the porous protruded portion 21a. Lithium metal, lithium alloy, or a combination thereof may be generated during the charging and discharging process of a lithium battery 100. The lithium alloy may be an alloy of lithium and a first metal. The first metal is, for example, tin (Sn), indium (In), gallium (Ga), aluminum (Al), titanium (Ti), zirconium (Zr), niobium (Nb), germanium (Ge), antimony (Sb), bismuth (Bi), zinc (Zn), gold (Au), platinum (Pt), palladium (Pd), nickel (Ni), iron (Fe), cobalt (Co), chromium (Cr), magnesium (Mg), cesium (Cs), cerium (Ce), silver (Ag), sodium (Na), potassium (K), calcium (Ca), yttrium (Y), bismuth (Bi), tantalum (Ta), hafnium (Hf), barium (Ba), vanadium (V), strontium (Sr), tellurium (Te), and lanthanum (La), or a combination thereof.

The alloy of lithium and a first metal include, for example, Li—Ag alloys, Li—Au alloys, Li—Al alloys, Li—Sn alloys, Li—In alloys, Li—Zn alloys, Li—Ge alloys, Li—Si alloys, Li—Sb alloys, Li—Bi alloys, Li—Ga alloys, Li—Na alloys, Li—K alloys, Li—Te alloys, Li—Mg alloys, Li—Mo alloys, Li—Sn—Bi alloys, Li—Sn—Ag alloys, Li—Sn—Na alloys, Li—Sn—K alloys, Li—Sn—Ca alloys, Li—Te—Ag alloys, Li—Sb—Ag alloys, Li—Sn—Sb alloys, Li—Sn—V alloys, Li—Sn—Ni alloys, Li—Sn—Cu alloys, Li—Sn—Zn alloys, Li—Sn—Ga alloys, Li—Sn—Ge alloys, Li—Sn—Sr alloys, Li—Sn—Y alloys, Li—Sn—Ba alloy, Li—Sn—Au alloy, Li—Sn—La alloy, Li—Al—Ga alloy, Li—Mg—Sn alloy, Li—Mg—Al alloy, Li—Mg—Si alloy, Li—Mg—Zn alloy, Li—Mg—Ga alloy, Li—Mg—Ag alloy or a combination thereof. The size of the lithium metal, lithium alloy or a combination thereof is, for example, about 0.1 nm to about 300 nm, about 0.1 nm to about 200 nm, or about 100 nm to about 300 nm. As used herein, “size” refers to the particle diameter when the particle to be measured is spherical, and refers to the major axis length when the particle is non-spherical. The particle diameter is, for example, an average particle diameter, and the major axis length is, for example, an average major axis length. The average particle diameter and average major axis length represent the averages of the measured particle diameter and measured major axis length, respectively. The particle size may be assessed using a scanning electron microscope or a transmission electron microscope. The average particle diameter is the average particle diameter observed, for example, using a scanning electron microscope (SEM), and may be calculated as the average value of the particle diameters of about 10 to 30 particles using SEM images.

Referring to FIGS. 1A, 1B and 7 to 13, the anode current collector may include a plurality of porous protruded portions 21a and a non-protruded portion 21b between the porous protruded portions 21a, and the porous protruded portions 21a include a porous metal-containing framework 21c. The non-protruded portion 21b of the anode current collector may be plate-shaped or foil-shaped. The non-protruded portion 21b of the anode current collector may be, for example, a material that reacts very little, or not at all, with lithium, i.e., does not form an alloy or compound with lithium. The non-protruded portion 21b of the anode current collector may include the same material as the porous protruded portion 21a.

The material constituting the non-protruded portion 21b of the anode current collector includes, but is not limited to, copper (Cu), nickel (Ni), stainless steel (SUS), aluminum (Al), indium (In), magnesium (Mg), titanium (Ti), iron (Fe), cobalt (Co), nickel (Ni), zinc (Zn), germanium (Ge), or a combination thereof, and any material that can be used as an anode current collector in the relevant technical field is possible. The non-protruded portion 21b of the anode current collector may be composed of one of the above-described metals or may be composed of an alloy or coating material of two or more of the metals.

Referring to FIGS. 1, 7, 8, 10, and 11, the non-protruded portion 21b of the anode current collector may be porous. The porous non-protruded portion 21b may have a shape of, for example, a metal foam or a metal mesh.

Referring to FIGS. 9, 12 and 13, the non-protruded portion 21b of the anode current collector may be nonporous. The nonporous non-protruded portion 21b may have the shape of, for example, a metal sheet, metal foil, or the like.

Alternatively, the non-protruded portion 21b of the anode current collector may include, for example, a conductive ceramic. For a specific type of conductive ceramic constituting the non-protruded portion 21b of the cathode current collector, reference is made to the conductive ceramic described above. The porous protruded portion 21a of the anode current collector includes a porous metal-containing framework 21c, and the porous metal-containing framework 21c may be selected from the materials constituting the non-protruded portion 21b.

Alternatively, the porous protruded portion 21a of the anode current collector may include, for example, a porous conductive ceramic-containing framework. For a specific type of conductive ceramic constituting the conductive ceramic-containing framework, reference is made to the conductive ceramic described above.

Referring to FIGS. 1A to 11, the secondary battery includes an anode-solid electrolyte assembly 60, and the anode-solid electrolyte assembly 60 includes a solid electrolyte 30.

The solid electrolyte 30 includes a base region 32 including a region from one surface facing the anode 10 to the bottom surface of the uptake room 31, and a frame region 33 including a region from the bottom surface of the uptake room 31 to one surface facing the insulating layer 50. The base region 32 separates the anode and cathode 10, provides a transfer path for lithium ions, and serves as a base that supports the uptake room 31. The frame region 33 forms the side of the uptake room and serves as a frame that supports the side surfaces of the uptake room. The solid electrolyte 30 is placed so as to face the cathode 10.

The solid electrolyte 30 may include an oxide-based solid electrolyte, a sulfide-based solid electrolyte, or a combination thereof.

The oxide-based solid electrolyte may include one or more selected from Li_{1+x+y}AlₓTi₂₋ₓSi_{y}P_{3-y}O₁₂ (0<x<2, 0≤y<3), Li₃PO₄, LiₓTi_{y}(PO₄)₃ (0<x<2, 0<y<3), LiₓAl_{y}Ti_{z}(PO₄)₃ (0<x<2, 0<y<1, 0<z<3), Li_{1+x+y}(Al,Ga)ₓ(Ti,Ge)₂₋ₓSi_{y}P_{3-y}O₁₂ (0≤x≤1, 0≤y≤1), LiₓLa_{y}TiO₃ (0<x<2, 0<y<3), Li₂O, LiOH, Li₂CO₃, LiAlO₂, Li₂O—Al₂O₃—SiO₂—P₂O₅—TiO₂—GeO₂, and Li₃₊ₓLa₃M₂O₁₂ (where M=Te, Nb, or Zr, and x is an integer from 1 to 10). The solid electrolytes may be produced by sintering methods, etc.

An example of an oxide-based solid electrolyte is a garnet-type solid electrolyte.

The garnet-based solid electrolyte may include, for example, an oxide represented by Formula 1.

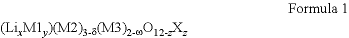

In Formula 1, 6≤x≤8, 0≤y<2, −0.2≤δ≤0.2, −0.2≤ω≤0.2, 0≤z≤2,
M1 is a monovalent cation, a divalent cation, a trivalent cation, or a combination thereof,
M2 is a monovalent cation, a divalent cation, a trivalent cation, or a combination thereof,
M3 is a monovalent cation, a divalent cation, a trivalent cation, a tetravalent cation, a pentavalent cation, a hexavalent cation, or a combination thereof, and
X is a monovalent, divalent, trivalent anion or a combination thereof.

Examples of monovalent cations in Formula 1 include Na, K, Rb, Cs, H, Fr, etc., and examples of divalent cations include Mg, Ca, Ba, Sr, etc. Examples of trivalent cations include In, Sc, Cr, Au, B, Al, Ga, etc., and examples of tetravalent cations include Sn, Ti, Mn, Ir, Ru, Pd, Mo, Hf, Ge, V, Si, etc. And examples of pentavalent cations include Nb, Ta, Sb, V, and P.

M1 may be, for example, hydrogen (H), iron (Fe), gallium (Ga), aluminum (Al), boron (B), beryllium (Be), or a combination thereof. M2 may be Lanthanum (La), barium (Ba), calcium (Ca), strontium (Sr), yttrium (Y), bismuth (Bi), praseodymium (Pr), neodymium (Nd), actinium (Ac), samarium (Sm), gallium (Gd) or a combination thereof, and M3 is zirconium (Zr), hafnium (Hf), tin (Sn), niobium (Nb), titanium (Ti), vanadium (V), chromium (Cr), manganese (Mn), cobalt (Co), nickel (Ni), copper (Cu), molybdenum (Mo), tungsten (W), tantalum (Ta), magnesium (Mg), technetium (Tc), ruthenium (Ru), palladium (Pd), iridium (Ir), scandium (Sc), cadmium (Cd), indium (In), antimony (Sb), tellurium (Te), Thallium (TI), platinum (Pt), silicon (Si), aluminum (Al), or a combination thereof.

In Formula 1, the monovalent anion used as X is a halogen atom, a pseudohalogen or a combination thereof, the divalent anion is S²⁻ or Se²⁻, and the trivalent anion is, for example, N³⁻.

In Formula 1, for example, 6.6≤x≤8, 6.7≤x≤7.5, or 6.8≤x≤7.1.

The garnet-based solid electrolyte may include, for example, an oxide represented by Formula 2.

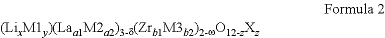

In Formula 2,
M1 is hydrogen (H), iron (Fe), gallium (Ga), aluminum (Al), boron (B), beryllium (Be), or a combination thereof,
M2 is barium (Ba), calcium (Ca), strontium (Sr), yttrium (Y), bismuth (Bi), praseodymium (Pr), neodymium (Nd), actinium (Ac), samarium (Sm), gallium (Gd), or a combination thereof,
M3 is hafnium (Hf), tin (Sn), niobium (Nb), titanium (Ti), vanadium (V), chromium (Cr), manganese (Mn), cobalt (Co), nickel (Ni), copper (Cu), molybdenum (Mo), tungsten (W), tantalum (Ta), magnesium (Mg), technetium (Tc), ruthenium (Ru), palladium (Pd), iridium (Ir), scandium (Sc), cadmium (Cd), indium (In), antimony (Sb), tellurium (Te), thallium (TI), platinum (Pt), silicon (Si), aluminum (Al), or a combination thereof,

$$6 \leq x \leq 8 , 0 \leq y < 2 , - 0.2 \leq δ \leq 0.2 , - 0.2 \leq ω \leq 0.2 , 0 \leq z \leq 2 \\ a 1 + a 2 = 1 , 0 < a 1 \leq 1 , 0 \leq a 2 < 1 , b 1 + b 2 = 1 , 0 < b 1 < 1 , 0 \leq b 2 < 1 ,$$

and
X is a monovalent anion, a divalent anion, a trivalent anion, or a combination thereof.

In Formula 2, the monovalent anion used as X is a halogen atom, a pseudohalogen or a combination thereof, the divalent anion is S²⁻ or Se²⁻, and the trivalent anion is, for example, N³⁻.

In Formula 2, for example, 6.6≤x≤8, 6.7≤x≤7.5, or 6.8≤x≤7.1.

As used herein, a “pseudohalogen” is a molecule composed of two or more electronegative atoms similar to halogens in the free state, which generate anions similar to halide ions. Examples of pseudohalogens include cyanide, cyanate, and thiocyanate, azide or a combination thereof.

Halogen atoms are, for example, iodine (I), chlorine (Cl), bromine (Br), fluorine (F), or combinations thereof, and pseudohalogens are, for example, cyanide, cyanate, thiocyanate, azide, or combinations thereof.

The trivalent anion is, for example, N³⁻.

In Formula 2, M3 is Al, Ga, In, Si, Ge, Sn, Sb, Bi, Sc, Y, Ti, Hf, V, Nb, Ta, W, or a combination thereof.

The garnet-type solid electrolyte may include, for example, an oxide represented by Formula 3.

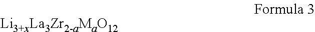

In Formula 3, M is Al, Ga, In, Si, Ge, Sn, Sb, Bi, Sc, Y, Ti, Hf, V, Nb, Ta, W, or a combination thereof, x is a number from 1 to 10, and 0≤a<2.

The garnet-type solid electrolyte may include, for example, Li₇La₃Zr₂O₁₂, Li_{6.5}La₃Zr_{1.5}Ta_{0.5}O₁₂, etc.

Alternatively, the solid electrolyte 30 may include, for example, a sulfide-based solid electrolyte.

The sulfide-based solid electrolyte may include, for example, one or more selected from Li₂S—P₂S₅, Li₂S—P₂S₅—LiX (where X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m, n are positive numbers, Z is one of Ge, Zn, or Ga), Li₂S—GeS₂, Li₂S—SiS₂—Li₃PO₄, Li₂S—SiS₂—LiₚMO_{q} (where p, q are positive numbers, M is one of P, Si, Ge, B, Al, Ga, In), Li₇₋ₓPS₆₋ₓClₓ (0≤x≤2), Li₇₋ₓPS₆₋ₓBrₓ (0≤x≤2), and Li₇₋ₓPS₆₋ₓIₓ (0x≤2). The sulfide-based solid electrolytes are produced by processing starting materials such as Li₂S and P₂S₅ using a melting and rapid cooling method or mechanical milling method. Additionally, heat treatment may be performed after this treatment. The sulfide-based solid electrolytes may be amorphous, crystalline, or a mixture of these.

In addition, the sulfide-based solid electrolyte may include, for example, at least sulfur (S), phosphorus (P), and lithium (Li) as constituent elements among the above-described sulfide-based solid electrolyte materials. For example, the sulfide-based solid electrolyte may be a material including Li₂S—P₂S₅. When using a sulfide—based solid electrolyte material containing Li₂S—P₂S₅, the mixing molar ratio of Li₂S and P₂S₅ is, for example, in the range of Li₂S:P₂S₅=about 50:50 to about 90:10.

The sulfide-based solid electrolyte may be an argyrodite-type compound including at least one selected from Li₇₋ₓPS₆₋ₓClₓ, 0≤x≤2, Li₇₋ₓPS₆₋ₓBrₓ, 0≤x≤2, and Li₇₋ₓPS₆₋ₓIₓ, 0≤x≤2. For example, the sulfide-based solid electrolyte included in the solid electrolyte may be an argyrodite-type compound including at least one selected from Li₆PS₅Cl, Li₆PS₅Br, and Li₆PS₅I.

The solid electrolyte 30 may further include, for example, a binder. The binder included in the solid electrolyte 30 may be, for example, styrene butadiene rubber (SBR), polytetrafluoroethylene, polyvinylidene fluoride, polyethylene, etc., but is not limited thereto, and any binder used in the relevant technical field may be used. The binder of the solid electrolyte 30 may be selected from the binders used in the cathode active material layer 12 and the anode active material layer.

### [Secondary Battery Preparing Method: Anode-Solid Electrolyte Assembly Preparing Method]

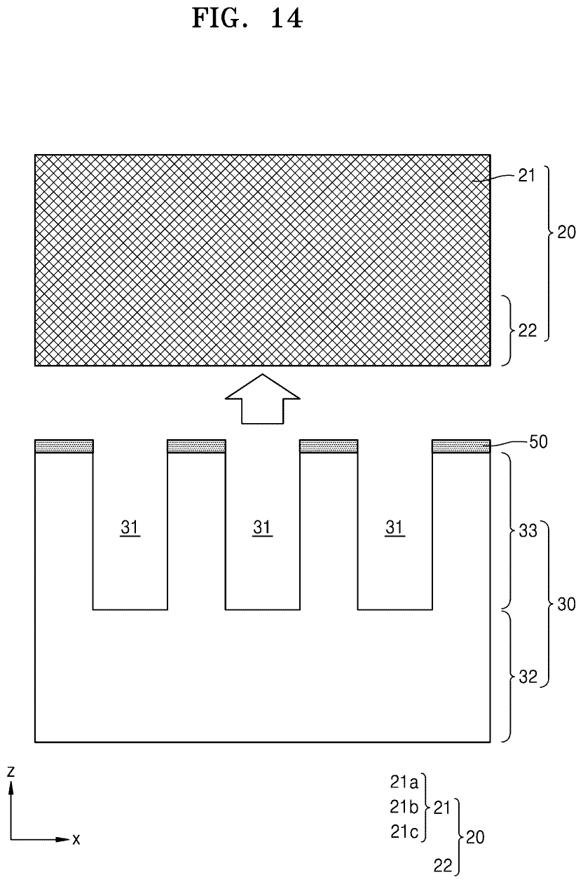

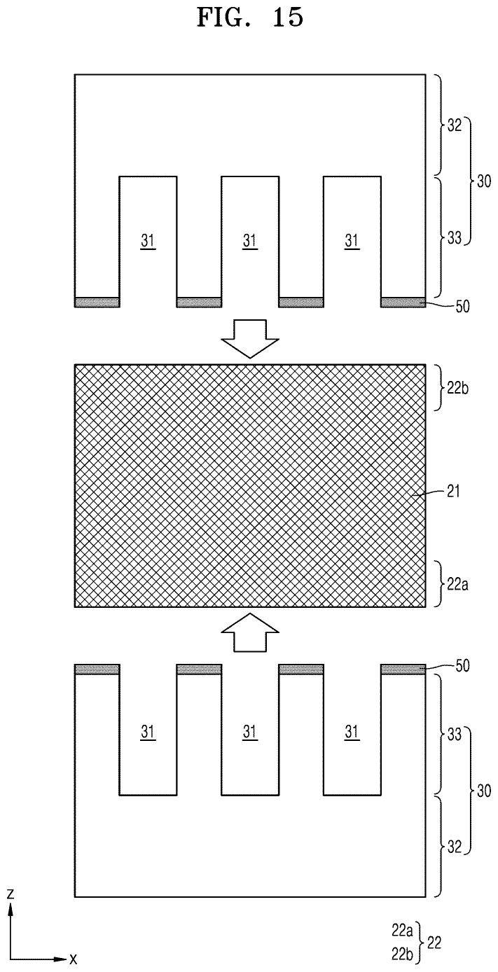

FIG. 14 is a schematic view showing a method of preparing an anode-solid electrolyte assembly included in a monocell-type secondary battery according to an embodiment. FIG. 15 is a schematic view showing a method of preparing an anode-solid electrolyte assembly 60 included in a bicell-type secondary battery according to an embodiment.

The method of preparing a secondary battery according to another embodiment includes a method of preparing an anode-solid electrolyte assembly 60. The method of preparing an anode-solid electrolyte assembly 60 includes: applying an interlayer 22 onto at least one surface of a porous anode current collector to provide a porous interlayer 22-coated porous anode current collector; providing a solid electrolyte 30 including a plurality of uptake rooms and an insulating layer 50 disposed between the uptake rooms; disposing the solid electrolyte 30 on the porous anode current collector, with the plurality of uptake rooms 31 facing the porous anode current collector to prepare a laminate; and pressing the laminate to accommodate the protruded portions of the porous anode current collector within the plurality of uptake rooms 31.

Referring to FIGS. 14 and 15, an interlayer 22 is applied onto at least one surface of a porous anode current collector to provide a porous anode current collector coated with the interlayer 22.

The process of providing a porous interlayer 22-coated porous anode current collector includes, for example, providing a porous anode current collector and applying an interlayer 22 onto the porous anode current collector.

The porous anode current collector is, for example, an anode current collector that includes a porous region in at least a portion of its area. The volume of the porous region may be, for example, about 70% to about 100%, about 75% to about 100% or about 80% to about 100% of the total volume of the porous anode current collector. The entire area of the porous anode current collector may be a porous area. The porous anode current collector may be, for example, metal foam, metal mesh (meth), etc.

Alternatively, the porous anode current collector may have a structure including a porous region in a region adjacent to, for example, at least one of the upper and lower surfaces of the porous anode current collector and a central region including a non-porous region. A porous anode current collector may have, for example, an upper 50% of the total thickness as a porous region and a lower 50% as a non-porous region. A porous anode current collector may have, for example, an upper 30% and a lower 30% of the total thickness as porous regions and a central 40% as non-porous regions.

The porous anode current collector may have a structure in which a metal foam, metal mesh, etc. are formed on one or both surfaces of a non-porous anode current collector, such as a metal sheet or metal foil. The porous anode current collectors may be prepared by various methods. For example, a Cu/Ga alloy may be formed by uniformly applying liquid metal (Ga) onto copper foil at 80° C. and then annealing at 100° C. The Cu/Ga alloy may then be subjected to dealloying in an acidic solution to prepare a porous anode current collector.

An interlayer 22 is applied onto the porous anode current collector.

To apply the interlayer 22, a slurry for forming the interlayer 22 is prepared. The slurry for forming the interlayer 22 may be prepared by mixing a carbon-based material, a metal-based material, or a combination thereof included in the interlayer 22, a binder, and a solvent. The carbon-based materials and metal-based materials may be selected from the materials used in the interlayer 22 of the above-described anode-solid electrolyte assembly 60. A PVA-PAA binder may be used as a binder, but is not limited to such a binder and may be selected from binders used in the cathode 10 of the lithium battery 100 below. NMP may be used as a solvent, but is not limited to such solvent and may be selected from solvents used in the preparation of the lithium battery 100 below. The slurry for forming the interlayer 22 is applied onto one or both sides of an anode current collector and then dried to prepare a porous anode current collector coated with an interlayer 22.

Alternatively, the slurry for forming the interlayer 22 may be applied onto a separate substrate and dried to form a preliminary interlayer 22, and then the preliminary interlayer 22 may be applied onto one or both sides of a porous anode current collector together with the substrate, and then the substrate may be removed to prepare a porous anode current collector coated with the interlayer 22.

Referring to FIGS. 14 and 15, a solid electrolyte 30 including a plurality of uptake rooms and an insulating layer 50 disposed between them is provided.

The process of providing a solid electrolyte 30 including a plurality of uptake roms and an insulating layer 50 disposed between them includes, for example, providing a solid electrolyte 30; introducing an insulating layer 50 onto one surface of the solid electrolyte 30; and introducing a uptake room 31 onto one surface of the solid electrolyte 30 onto which the insulating layer 50 is introduced.

First, a solid electrolyte 30 is provided. The solid electrolyte 30 includes an oxide-based solid electrolyte, a sulfide-based solid electrolyte, or a combination thereof. The solid electrolyte 30 may be selected, for example, from the solid electrolytes 30 used in the anode-solid electrolyte assembly 60 described above.

Next, an insulating layer 50 is introduced onto one surface of the solid electrolyte 30. The process of introducing the insulating layer 50 is not particularly limited, and for example, dry coating, wet coating, etc. may be used. Dry coating may be used, for example, sputtering, CVD, PVD, ALD, etc., but is not particularly limited as long as it is used as a deposition method for forming an insulating layer 50. Wet coating may be performed, for example, by applying a slurry containing a material for forming an insulating layer 50 and a solvent and then annealing. The solvent is removed by annealing and the material for forming the insulating layer 50 may form a sintered layer.

The insulating layer 50 material may be, for example, an insulating metal oxide such as aluminum oxide. The insulating layer 50 material may be selected, for example, from the insulating layer 50 materials used in the anode-solid electrolyte assembly 60 described above.

Next, the uptake rooms 31 are introduced onto one surface of a solid electrolyte 30, which is coated with the insulating layer 50.

The uptake rooms 31 may be formed, for example, inside the solid electrolyte 30 by processing using one or more techniques such as laser drilling, stamping, etching, chemical milling, laser scribing, water jet cutting, nano imprinting, and tape casting methods, or a combination thereof. The uptake rooms 31 may correspond, for example, to grooves. The uptake rooms 31 may be introduced spaced apart from one surface of the solid electrolyte 30. The uptake rooms 31 may be introduced periodically spaced apart on one surface of the solid electrolyte 30, introduced regularly spaced apart, or introduced spaced apart in a pattern. The uptake rooms 31 are void spaces formed by indentation from the surface of the solid electrolyte 30 in a direction perpendicular or non-perpendicular to the surface. The uptake rooms 31 may correspond to grooves having, for example, a plate shape, a rod shape, a cone shape, a pyramid shape, or a combination thereof. The depth and/or shape of the uptake rooms 31 may be determined in consideration of the height and/or shape of the required protruded portions. The depth and/or shape of the uptake rooms 31 may be determined by considering the volume of lithium supplied from the cathode 10.

Referring to FIGS. 14 and 15, a solid electrolyte 30 is arranged on a porous anode current collector so that a plurality of uptake rooms 31 face the porous anode current collector, thereby preparing a laminate.

A solid electrolyte 30 is arranged on one or both surfaces of a porous anode current collector so that a plurality of uptake rooms 31 face the porous anode current collector, thereby preparing a laminate. An insulating layer 50 is placed between the porous anode current collector and the solid electrolyte 30.

Referring to FIGS. 14 and 15, the prepared laminate is pressed in the thickness direction of the laminate to accommodate the protrusion m members of the porous anode current collector within the plurality of uptake rooms 31.

When the prepared laminate is pressed in the thickness direction of the laminate, the porous anode current collector region facing the insulating layer 50 is compressed and retreats along the pressing direction by the solid electrolyte 30, and the porous anode current collector region facing the uptake rooms 31 is not compressed by the solid electrolyte 30, and as a result, it protrudes and is accommodated within the uptake rooms 31. The anode-solid electrolyte assembly 60 is prepared. The pressing force and speed may be adjusted depending on the desired shape of the protruded portions or the like.

Alternatively, the anode-solid electrolyte assembly 60 may be prepared by separately preparing an anode current collector including the porous protruded portions 21a as shown in FIGS. 11 through 13.

For example, a substrate having uptake rooms 31 with the same shape as a solid electrolyte 30 having uptake rooms 31 may be prepared separately. The substrate having uptake rooms 31 may be placed on one surface of the anode current collector to prepare a laminate, and the laminate may be pressed to prepare an anode current collector including the porous protruded portions 21a of FIGS. 11 to 13.

Next, although not shown in the drawings, a slurry for forming an interlayer 22 is applied onto the porous protruded portions 21a of the anode current collector including the porous protruded portions 21a of FIGS. 11 to 13, and then dried so that the interlayer 22 may be selectively introduced on the porous protruded portions 21a. A solid electrolyte 30 may be arranged on the anode current collector including the porous protruded portions 21a coated with an interlayer 22 so that a plurality of uptake rooms 31 accommodate the porous protruded portions 21a, thereby preparing the anode-solid electrolyte assembly. In this case, since pressurization is not required, deformation of the anode current collector that occurs during the pressurization process may be avoided, and an anode-solid electrolyte assembly 60 including more uniformly shaped porous protruded portions 21a may be prepared.

### Secondary Battery: Lithium Battery

The secondary battery may be, for example, a solid-state battery. The solid-state battery may be, for example, an all-solid-state battery. The secondary battery according to an embodiment is, for example, a lithium battery 100.

The lithium battery 100 includes the above-described anode-solid electrolyte assembly 60; and a cathode 10 disposed on the solid electrolyte 30 of the anode-solid electrolyte assembly 60.

In a lithium battery 100 including an anode-solid electrolyte assembly 60, since volume change during charging and discharging is prevented, an elastic member and/or a pressurizing member for suppressing volume change may be omitted, thereby improving the energy density of the lithium battery 100. In a lithium battery 100 including an anode-solid electrolyte assembly 60, since volume changes during charging and discharging are prevented, an increase in interfacial resistance due to volume changes during charging and discharging is suppressed, which leads to improved high-rate performance of the lithium battery 100.

The lithium battery 100 may be used in electronic devices, vehicles, and other applications. The lithium battery 100 is not particularly limited and may be, for example, a lithium ion battery, a lithium air battery, or the like. The lithium battery 100 may be, for example, a solid-state battery. A more detailed description of the lithium battery 100 is provided below.

FIGS. 7 to 10 are schematic diagrams of a lithium battery 100 according to an embodiment. The lithium battery 100 includes the anode-solid electrolyte assembly 60, and a cathode 10 disposed on the solid electrolyte 30 of the anode-solid electrolyte assembly 60. The lithium battery 100 may be prepared, for example, as follows.

### Monocell Lithium Battery

FIGS. 7 to 9 are cross-sectional views of a monocell-type lithium battery 100, in which a solid electrolyte 30 and a cathode 10 are arranged on one surface of a anode current collector.

The monocell-type lithium battery 100 may be prepared as follows. First, the cathode 10 is prepared. The cathode 10 may be prepared by forming a cathode active material layer including a cathode active material on a cathode current collector.

The cathode active material layer 12 may be prepared by a vapor-phase method or a solid-phase method. The vapor-phase method may include techniques such as pulse laser deposition (PLD), sputtering, and chemical vapor deposition (CVD), but is not limited to these and may include any applicable method known in the art. The solid-phase method may include sintering, sol-gel processing, doctor blade coating, screen printing, slurry casting, and powder compaction, but is not limited to these and may include any applicable method known in the art.

The cathode active material layer 12 may be prepared, for example, as follows. A cathode active material composition is prepared by mixing a cathode active material, a conductive agent, a binder, and a solvent. The cathode active material composition may be directly applied and dried on the cathode current collector 11 to prepare the cathode 10, or the cathode active material composition may be cast on a separate support, and then the film obtained by peeling off the support may be laminated onto the cathode current collector 11 to prepare the cathode 10. Alternatively, the cathode active material composition may be prepared in the form of electrode ink containing an excess amount of solvent, and the cathode 10 may be fabricated by printing the ink onto the cathode current collector 11 using an inkjet or gravure printing method. The printing method is not limited to these examples and may include any general coating or printing technique available in the art.

The cathode active material layer 12 includes a cathode active material.

The cathode active material may be any material commonly used in lithium batteries, without particular limitation. The cathode active material may be, for example, a lithium transition metal oxide, a transition metal sulfide, or the like. The lithium transition metal oxide may include, for example, at least one composite oxide of lithium and a metal selected from cobalt, manganese, nickel, and a combination thereof. Examples of the cathode active material may include compounds represented by any one of the following chemical formulas: LiₐA_{1-b}B′_{b}D₂ (where 0.90≤a≤1, and 0≤b≤0.5; LiₐE_{1-b}B′_{b}O_{2-c}D_{c} (where 0.90≤a≤1, 0≤b≤0.5, 0≤c≤0.05); LiE_{2-b}B′_{b}O_{4-c}D_{c} (where 0≤b≤0.5, 0≤c≤0.05); LiₐNi_{1-b-c}Co_{b}B′_{c}D_{α} (where 0.90≤a≤1, 0≤b≤0.5, 0≤c≤0.05, 0<α≤2); LiₐNi_{1-b-c}Co_{b}B′_{c}O_{2-α}F′_{α} (where 0.90≤a≤1, 0≤b≤0.5, 0≤c≤0.05, 0<α<2); LiₐNi_{1-b-c}Mn_{b}B′_{c}D_{α} (where 0.90≤a≤1, 0≤b≤0.5, 0≤c≤0.05, 0<α≤2); LiₐNi_{1-b-c}Mn_{b}B′_{c}O_{2-α′}F′_{α} (where 0.90≤a≤1, 0≤b≤0.5, 0≤c≤s 0.05, 0<α<2); LiₐNi_{b}E_{c}G_{d}O₂ (where 0.90≤a≤1, 0≤b≤0.9, 0≤c≤0.5, 0.001≤d≤0.1); LiₐNi_{b}Co_{c}Mn_{d}GₑO₂ (where 0.90≤a≤1, 0≤b≤0.9, 0≤c≤0.5, 0≤d≤50.5, 0.001≤e≤0.1); LiₐNiG_{b}O₂ (where 0.90≤a≤1, 0.001≤b≤0.1); LiₐCoG_{b}O₂ (where 0.90≤a≤1, 0.001≤b≤0.1); LiₐMnG_{b}O₂ (where 0.90≤a≤1, 0.001≤b≤0.1); LiₐMn₂G_{b}O₄ (where 0.90≤a≤1, 0.001≤b≤0.1); QO2; QS2; LiQS2; V₂O₅; LiV₂O₅; LiI′O₂; LiNiVO₄; Li_{(3-f)}J₂(PO₄)₃ (0≤f≤2); Li_{(3-f)}Fe₂(PO₄)₃ (0≤f≤2); LiFePO₄. In the above Formulae, A is Ni, Co, Mn, or a combination thereof; B′ is Al, Ni, Co, Mn, Cr, Fe, Mg, Sr, V, a rare earth element, or a combination thereof; D is O, F, S, P, or a combination thereof; E is Co, Mn, or a combination thereof; F′ is F, S, P, or a combination thereof; G is Al, Cr, Mn, Fe, Mg, La, Ce, Sr, V, or a combination thereof; Q is Ti, Mo, Mn, or a combination thereof; I′ is Cr, V, Fe, Sc, Y, or a combination thereof; J is V, Cr, Mn, Co, Ni, Cu, or a combination thereof. Examples of the cathode active materials include LiCoO₂, LiMnₓO₂ₓ (x=1, 2), LiNi₁₋ₓMnₓO₂ₓ (0<x<1), Ni_{1-x-y}CoₓMn_{y}O₂ (0≤x≤0.5, 0≤y≤0.5), LiFePO₄, TiS₂, FeS₂, TiS₃, and FeS₃.

The cathode active material may be covered by a coating layer. The coating layer may be any layer known as a coating layer of the cathode active material of a multilayer ceramic battery. For example, the coating layer may be Li₂O—ZrO₂ (LZO).

The particle size of the cathode active material may be, for example, about 0.1 μm to about 20 μm, about 0.5 μm to about 10 μm or about 1 μm to about 5 μm. The cathode active material may be, for example, a single crystal particle or a polycrystalline particle.

The shape of the cathode active material may be, for example, spherical, elliptical, or nearly spherical. The particle size of the cathode active material is not particularly limited and may fall within a range applicable to cathode active materials of conventional solid-state batteries. The content of the cathode active material of the cathode active material layer 12 is not particularly limited and is within a range applicable to the cathode active material layer 12 of a conventional solid-state battery. The content of the cathode active material included in the cathode active material layer 12 may be about 80 wt % to about 99 wt %, about 80 wt % to about 95 wt %, or about 80 wt % to about 90 wt % of the total weight of the cathode active material layer 12.

The cathode active material layer 12 may further include a solid electrolyte 30. The solid electrolyte 30 may be selected from the solid electrolytes used in the solid electrolyte 30 of the anode-solid electrolyte assembly 60. The solid electrolyte content of the cathode active material layer 12 may be about 0.1 wt % to about 50 wt %, about 1 wt % to about 40 wt %, or about 10 wt % to about 30 wt % of the total weight of the cathode active material layer 12.

The cathode active material layer 12 may further include a conductive material, a binder, or a combination thereof.

The conductive material may include, for example, a carbon-based conductive material. The carbon-based conductive materials may include, for example, carbon black, carbon fibers, graphite, fluorocarbon, or a combination thereof. The carbon black may be, for example, acetylene black, Ketjen black, Super P carbon, channel black, furnace black, lamp black, thermal black or a combination thereof. Graphite may be natural or artificial graphite. The cathode active material layer 12 may further include a metal-based conductive agent, a metal oxide-based conductive agent, or a polymer-based conductive agent in addition to the carbon-based conductive agent described above. The metal-based conductive material may be, for example, a metal fiber, a metal powder such as aluminum powder or nickel powder, a conductive metal oxide such as zinc oxide or potassium titanate, or a polyethylene derivative. The content of the conductive agent may be about 1 part to about 10 parts by weight, or about 2 parts to about 7 parts by weight, based on 100 parts by weight of the cathode active material.

The binder may improve the adhesion between components of the cathode active material layer 12 and the adhesion of the cathode active material layer 12 to the cathode current collector 123. The binder may include, for example, polyacrylic acid (PAA), polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene-butadiene-rubber, fluorinated rubber, copolymers thereof, or a combination thereof. The content of the binder may be about 1 part to about 10 parts by weight, or about 2 parts to about 7 parts by weight, based on 100 parts by weight of the cathode active material. The binder may be partially or completely removed by vaporization and/or carbonization during the sintering process of the cathode active material layer 121, 122. The binder may be omitted.

The cathode current collector 11 may include, for example, a metal-based substrate or a carbon-based substrate. As the metal-based substrate, for example, a porous body, mesh, plate or foil made of stainless steel, nickel (Ni), aluminum (Al), indium (In), copper (Cu), magnesium (Mg), titanium (Ti), iron (Fe), cobalt (Co), nickel (Ni), zinc (Zn), germanium (Ge), lithium (Li), or an alloy thereof may be used. The cathode current collector 11 may be, for example, a sintered product of metal powder used in the metal substrate described above. The carbon-based substrate may include, for example, one-dimensional carbon-based materials such as carbon fibers or carbon tubes, two-dimensional carbon-based materials such as graphite or graphene, or a combination thereof. The cathode current collector 11 may further include a binder. The binder may be selected from the binders used in the cathode active material layer 12. The cathode current collector 11 may be omitted.

Alternatively, the cathode 10 may be impregnated in, for example, a liquid electrolyte. The liquid electrolyte may include, for example, a lithium salt; and one or more of an ionic liquid and a polymer ionic liquid. The liquid electrolyte may be nonvolatile at room temperature and pressure. An ionic liquid refers to a salt or room-temperature molten salt that is in a liquid state at room temperature and consists solely of ions, with a melting point at or below room temperature. The ionic liquid may include one selected from compounds including a) at least one cation selected from ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, triazolium-based cations and mixtures thereof, and, and b) at least one anion selected from BF₄⁻, PF₆⁻, AsF₆⁻, SbF₆⁻, AlCl₄⁻, HSO₄⁻, ClO₄⁻, CH₃SO₃—, CF₃CO₂—, Cl⁻, Br⁻, I⁻, SO₄²⁻, CF₃SO₃⁻, (FSO₂)₂N⁻, (C₂F₅SO₂)₂N⁻, (C₂F₅SO₂)(CF₃SO₂)N⁻, and (CF₃SO₂)₂N⁻. Examples of the ionic liquid include, for example, at least one selected from N-methyl-N-propylpyrrolidinium bis(trifluoromethanesulfonyl)imide, N-butyl-N-methylpyrrolidinium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide. The polymer ionic liquid may include repeating units including a) one or more cations selected from ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, triazolium-based cations and mixtures thereof, and b) one or more anions selected from BF₄—, PF₆—, AsF₆—, SbF₆—, AlCl₄—, HSO₄—, ClO₄—, CH₃SO₃—, CF₃CO₂—, (CF₃SO₂)₂N—, (FSO₂)₂N—, Cl—, Br—, I—, SO₄²—, CF₃SO₃—, (C₂F₅SO₂)₂N—, (C₂F₅SO₂)(CF₃SO₂)N—, NO₃—, Al₂Cl₇—, (CF₃SO₂)₃C—, (CF₃)₂PF₄—, (CF₃)₃PF₃—, (CF₃)₄PF₂—, (CF₃)₅PF—, (CF₃)₆P—, SF₅CF₂SO₃—, SF₅CHFCF₂SO₃—, CF₃CF₂(CF₃)₂CO—, CF₃SO₂)₂CH—, (SF₅)₃C—, and (O(CF₃)₂C₂(CF₃)₂₀)₂PO—.

The lithium salt may include any lithium salt known and usable in the relevant technical field. The lithium salts may include, for example, LiPF₆, LiBF₄, LiSbF₆, LiAsF₆, LiClO₄, LiCF₃SO₃, Li(CF₃SO₂)₂N, Li(FSO₂)₂N, LiC₄F₉SO₃, LiAlO₂, LiAlCl₄, LiN(CₓF₂ₓ₊₁SO₂)(C_{y}F_{2y+1}SO₂)(where 1<x<20, 1<y<20), LiCl, LiI or mixtures thereof. The concentration of the lithium salt contained in the liquid electrolyte may be about 0.1 M to about 5 M. The content of the liquid electrolyte impregnated in the cathode 10 may be, for example, about 0 part to about 100 parts by weight, about 0 part to about 50 parts by weight, about 0 part to about 30 parts by weight, about 0 part to about 20 parts by weight, about 0 part to about 10 parts by weight, or about 0 part to about 5 parts by weight, based on 100 parts by weight of the cathode active material layer not including the liquid electrolyte.

Next, the anode-solid electrolyte assembly 60 is prepared as described above.

A cathode 10 is then disposed on the solid electrolyte 30 of the anode-solid electrolyte assembly 60, thereby completing the preparation of the monocell lithium battery 100.

### Bicell Lithium Battery

FIG. 10 is a cross-sectional view of a lithium battery 100 having a bicell structure according to an embodiment. The bicell-type lithium battery 100 may be prepared as follows. The cathode 10 is prepared in the same manner as in the monocell-type lithium battery 100. The cathode 10 includes a first cathode 10a and a second cathode 10b. The first cathode 10a and the second cathode 10b may be the same or different. The first cathode 10a includes a first cathode current collector 11a and a first cathode active material layer 12a on the first cathode current collector 11a. The second cathode 10b includes a second cathode current collector 11b and a second cathode active material layer 12b on the second cathode current collector 11b.

Next, as described above, an anode-solid electrolyte assembly 60 is prepared in which the first solid electrolyte 30a and the second solid electrolyte 30b are respectively disposed on opposite sides of an anode current collector. The first solid electrolyte 30a and the second solid electrolyte 30b may be the same or different. The anode-solid electrolyte assembly 60 includes an anode current collector, and the anode current collector includes a plurality of porous protruded portions 21a on both sides and a non-protruded portions 21b between the porous protruded portions 21a. An insulating layer 50 is placed between the non-protruded portion 21b and the first solid electrolyte 30. A first insulating layer 50a is placed between the non-protruded portion 21b and the first solid electrolyte 30a. A second insulating layer 50b is placed between the non-protruded portion 21b and the second solid electrolyte 30b.

An interlayer 22 is arranged along the porous metal-containing framework 21ca on the porous metal-containing framework 21c of the porous protruded portion 21a. The plurality of protruded portions include a first porous protruded portion 21aa protruding in a direction facing the first solid electrolyte 30a and a second porous protruded portion 21ab protruding in a direction facing the second solid electrolyte 30b. The first porous protruded portion 21aa includes a first porous metal framework 21ca, and a first interlayer 22a is arranged along the first porous metal-containing framework 21ca on the first porous metal-containing framework 21ca. The second porous protruded portion 21ab includes a second porous metal-containing framework 21cb, and a second interlayer 22a is arranged along the second porous metal-containing framework 21cb on the second porous metal-containing framework 21cb. The interlayer may be arranged on at least a portion of the porous metal-containing framework 21cb. The interlayer may be in the form of a coating applied to at least a portion of the metal-containing framework 21cb. The interlayer 22a may be in the form of a coating along the metal-containing framework 21cb.

By disposing the first cathode 10a and the second cathode 10b on the first solid electrolyte 30a and the second solid electrolyte 30b, respectively, the bicell-type lithium battery 100 is completed. The bicell-type lithium battery 100, having a symmetrical structure, may more effectively prevent the occurrence of non-uniform stress caused by lithium deposition during charging.

Hereinafter, the disclosure will be described in detail with reference to examples and comparative examples, but is not limited to the following examples.

### Example 1: Monocell with 3D Porous Anode Current Collector within Plate-Shaped Uptake Rooms

### Preparation of Solid Electrolyte

A 350 μm-thick LLZTO (Li_{6.5}La₃Zr_{1.5}Ta_{0.5}O₁₂) pellet is prepared as the solid electrolyte.

An insulating layer is formed by depositing aluminum oxide on an upper surface of the solid electrolyte using sputtering. Thereafter, laser drilling is performed on the solid electrolyte with the insulating layer to form a plurality of uptake rooms in specific regions, thereby providing volumetric spaces for the uptake rooms for accommodating the protruded portions of the anode current collector. The plurality of uptake rooms is formed periodically in a defined pattern. The uptake rooms are formed to have a plate-like shape.

The volume of the uptake rooms in the solid electrolyte is designed to correspond to the capacity of the cathode. The total volume of the plurality of uptake rooms is formed to be greater than the volume of lithium that is deposited when the cell is charged to 100% SOC (State of Charge) from the cathode.

### Preparation of Anode-Solid Electrolyte Assembly

3 g of carbon black (CB) having a particle size of about 10 nm, and 1 g of silver (Ag) particles having an average particle diameter of about 4 nm to 17 nm are mixed, a mixture obtained by mixing 2.692 g of a PVA-PAA binder solution (Solvay Specialty Polymers. Solef 5130) with 7 g of N-methyl-2-pyrrolidone (NMP) is added to the mixture of carbon and silver particles, and the mixture is stirred at 1,000 rpm for 30 minutes to prepare a slurry for interlayer formation.

A copper foam is prepared as the porous anode current collector. The slurry for interlayer formation is applied onto one side of the copper porous anode current collector, dried at room temperature (25° C.) for 1 hour, and then vacuum dried at 120° C. for 12 hours to provide a porous anode current collector coated with the interlayer. The interlayer may be disposed on at least a portion of the copper framework of the copper foam. The interlayer may be in the form of a coating on at least a portion of the copper framework.

The porous anode current collector is placed on a non-porous substrate, and the solid electrolyte is positioned such that the uptake rooms of the solid electrolyte are adjacent to the porous anode current collector, thereby preparing a preliminary laminate. The preliminary laminate is pressed in the thickness direction to prepare an anode-solid electrolyte laminate.

In the anode-solid electrolyte laminate, the region of the porous anode current collector that faces the uptake rooms of the solid electrolyte protrudes into the uptake rooms forming porous protruded portions coated with the interlayer. The region of the porous anode current collector that faces the insulating layer of the solid electrolyte is compressed by the solid electrolyte. As a result, the porosity of the compressed region of the porous anode current collector is lower than that of the plurality of porous protruded portions.

The anode current collector includes a plurality of porous protruded portions and a non-protruded portion (flat portions) between them. The porous protruded portions of the anode current collector are accommodated within the uptake rooms of the solid electrolyte, and an insulating layer is disposed between the non-protruded portion of the anode current collector and the solid electrolyte, thereby completing the anode-solid electrolyte assembly.

### Cathode Preparation

LiNi_{0.9}Co_{0.1}Mn_{0.1}O₂(NCM) is prepared as the cathode active material and includes polytetrafluoroethylene (Teflon (registered trademark) binder from DuPont) as a binder. The binder is used as a solution dissolved in NMP at a content of 5 wt %. Denka Black (DB) is used as the conductive additive. The cathode active material, conductive additive, and binder are mixed in a weight ratio of 100:2:1 to prepare a cathode active material slurry. The cathode slurry is applied onto an 18 μm thick aluminum foil current collector and dried at 120° C. for 12 hours, followed by pressing, to prepare a cathode including the cathode current collector and the cathode active material layer.

The cathode active material layer of the cathode is impregnated with an electrolyte solution containing an ionic liquid, PYR13FSI (N-propyl-N-methyl-pyrrolidinium bis(fluorosulfonyl)imide), in which 2.0 M lithium bis(fluorosulfonyl)imide (LiFSI) is dissolved.

### Preparation of the Solid Secondary Battery

After being impregnated with the ionic liquid-containing electrolyte, the cathode is placed inside an SUS (stainless steel) cap with the cathode active material layer facing upward. The solid electrolyte of the anode-solid electrolyte assembly is placed on the cathode active material layer, and the structure is sealed to fabricate a solid-state secondary battery. The cathode and anode are electrically insulated from each other using an insulating material. Connecting members of the cathode current collector and the anode current collector are extended outside the sealed battery and used as the cathode terminal and anode terminal, respectively.

In the solid-state secondary battery, the porous protruded portions that are accommodated within the uptake rooms of the solid electrolyte include a porous copper (Cu) framework and an interlayer applied on the porous copper framework, which extends into an uptake room and is in contact with side surfaces of the uptake room in the solid electrolyte.

During charging of the prepared solid-state secondary battery, the interlayer of the porous protruded portion accommodated within the uptake room induces lithium deposition. As a result, lithium initially deposits in regions adjacent to the side surfaces of the uptake room in the solid electrolyte, and then deposited lithium fills the center of the uptake room. The deposited lithium exists in the form of a lithium alloy along with the interlayer material. The deposited lithium also fills the pores inside the porous protruded portion.

During discharging of the charged solid-state secondary battery, the deposited lithium moves to the cathode through the solid electrolyte at the side surfaces of the uptake room, and the interlayer material is restored as part of the porous protruded portion. Lithium alloy may remain on the porous protruded portion.

### Example 2: Monocell with 3D Porous Anode Current Collector

A solid secondary battery is prepared in the same manner as in Example 1, except that the uptake rooms of the solid electrolyte are formed in a hole shape when preparing the anode-solid electrolyte assembly.

### Example 3: Monocell with 3D Porous Anode Current Collector with Additional Insulating Layer at the Bottom of the Uptake Room

A solid-state secondary battery is prepared in the same manner as in Example 1, except that an additional aluminum oxide insulating layer is formed on a bottom (lower) surface of the uptake rooms of the solid electrolyte during the preparation of the anode-solid electrolyte assembly.

### Example 4: Bicell with 3D Porous Anode Current Collector with Plate-Shaped Uptake Rooms

A solid electrolyte having uptake rooms is prepared in the same manner as in Example 1.

A mixture including 3 g of CB with a particle size of approximately 10 nm as the carbon-based material and 1 g of Ag particles with an average particle diameter of about 4 nm to 17 nm is prepared. To this particle mixture, a mixture of 2.692 g of a PVA-PAA binder solution (Solef 5130, Solvay Specialty Polymers) is added to 7 g of NMP, and the resulting mixture is stirred at 1000 rpm for 30 minutes to prepare a slurry for interlayer formation.

A copper foam is prepared as the porous anode current collector. The slurry for interlayer formation is applied to one surface of the porous anode current collector, then dried at room temperature (25° C.) for 1 hour, followed by vacuum drying at 120° C. for 12 hours. An interlayer is also applied onto an opposite surface of the porous anode current collector in the same manner, thereby preparing a porous anode current collector having interlayers applied onto both surfaces of the copper foam. The interlayer may be disposed on the copper framework of the copper foam. The interlayer may be applied onto at least a portion of the copper framework.

The interlayer-coated porous anode current collector is placed on the first solid electrolyte such that it faces the uptake rooms of the first solid electrolyte. Then, the second solid electrolyte is placed on the opposite side of the porous anode current collector such that the uptake rooms of the second solid electrolyte face the porous anode current collector, thereby forming a first solid electrolyte/porous anode current collector/second solid electrolyte preliminary laminate. The preliminary laminate is pressed in the thickness direction to prepare the anode-solid electrolyte laminate.

In the anode-solid electrolyte laminate, the regions of the porous anode current collector that face the uptake rooms of the first and second solid electrolytes protrude into the uptake rooms, forming porous protruded portions coated with the interlayer. In the anode-solid electrolyte laminate, the regions of the porous anode current collector that face the insulating layers of the first and second solid electrolytes are compressed by the first and second solid electrolytes. As a result, the porosity of the compressed regions of the porous anode current collector is less than that of the porous protruded portions.

The anode current collector includes a plurality of porous protruded portions and a non-protruded portion (flat portions) formed on a surface and an opposite surface (two surfaces). The porous protruded portions formed on both surfaces of the anode current collector are respectively accommodated in the uptake rooms of the first solid electrolyte and the uptake rooms of the second solid electrolyte, respectively, and an insulating layer is disposed between the non-protruded portion of the anode current collector and the first and second solid electrolytes.

### Cathode Preparation

The cathode is prepared in the same manner as in Example 1.

### Preparation of the Solid-State Secondary Battery

The cathode is placed inside an SUS (stainless steel) cap with the cathode active material layer, impregnated with the ionic liquid-containing electrolyte, facing upward. The first solid electrolyte of the anode-solid electrolyte assembly is placed on the cathode active material layer. Then, a cathode is placed on the second solid electrolyte of the anode-solid electrolyte assembly, with the cathode active material layer facing downward. The structure is sealed to prepare the solid-state secondary battery. The cathode and anode are electrically insulated from each other using an insulating material. Connecting members of the cathode current collector and the anode current collector are protrude externally from the sealed battery and are used as the cathode terminal and anode terminal, respectively.

In the solid-state secondary batter with the porous protruded portions accommodated within the uptake rooms of the solid electrolyte are in contact with side surfaces of the uptake rooms of the solid electrolyte.

### Evaluation Example 1: High-Rate Performance and Thickness Change Calculation

To evaluate the high-rate performance and thickness variation of the solid-state secondary battery, the solid-state battery of Example 1 with the structure shown in FIG. 1A was modeled, and calculations were performed using COMSOL Multiphysics® software.

In the solid-state battery of Example 1, the thickness of the base region solid electrolyte layer 32 between the bottom of the uptake room and the cathode layer is 20 μm, the thickness of the frame region solid electrolyte layer 33 forming the sides of the uptake room is 15 μm, and the thickness of the porous anode current collector 21a disposed inside the uptake room is 15 μm. The porous anode current collector was modeled to include multiple framework structures with diameters of about 100 nm, aligned in one direction within the uptake room and with an interlayer applied onto the porous framework. The solid electrolyte is a garnet oxide (Li₇La₃Zr₂O₁₂), the cathode active material is LiNi_{0.33}Mn_{0.33}Co_{0.33}O₂ (NCM 111), and the porous anode current collector can be Cu foam. The ionic conductivity of the interlayer is 0.0077 S/m.

In Comparative Examples 1 and 2, the anode current collector is a Cu foil, and the comparative collectors do not include uptake rooms, insulating layers, or interlayers. The thickness of the solid electrolyte layer 32 is 500 μm in Comparative Example 1 and 20 μm in Comparative Example 2. In the modeling of Comparative Examples 1 and 2, the uptake room 31, insulating layer 50, and frame region solid electrolyte layer 33 as shown in FIG. 1B are all replaced with the base region solid electrolyte layer 32. In Comparative Examples 1 and 2, the anode current collector is in direct contact with the solid electrolyte layer.

For the modeled solid-state secondary batteries of Example 1, Comparative Example 1, and Comparative Example 2, charging and discharging were performed at 25° C. by applying a constant current of 0.2 C up to 4.35 V and discharging at a constant current of 0.2 C down to 2.75 V. Subsequently, another charge/discharge cycle was carried out by charging at 0.8 C and discharging at 1.0 C at 25° C. to evaluate high-rate performance. The high-rate performance is calculated according to Equation 1 below.

$$High - rate performance ( \% ) = ( Discharge capacity at 1. C / Discharge capacity at 0.2 C ) \times 100 \qquad Equation l$$

For the modeled solid-state secondary batteries of Example 1, Comparative Example 1, and Comparative Example 2, charging was performed at 25° C. using a constant current of 0.2 C up to 4.35 V, followed by discharging at a constant current of 0.2 C down to 2.75 V.

The thickness change of the solid-state secondary batteries before and after the charge/discharge cycle was calculated. The thickness change is defined as the percentage increase in the cell thickness after charging/discharging compared to the cell thickness before charging/discharging. The results are shown in Table 1 below.

TABLE 1
Modeled solid-state secondary batteries

| | Solid | Interlayer | | | High- | Cell |
|---|---|---|---|---|---|---|
| | Electrolyte | Ionic | 0.2 C | 1.0 C | Rate | Thick- |
| | Layer | Con- | Discharge | Discharge | Perfor- | ness |
| | Thickness | ductivity | Capacity | Capacity | mance | Change |
| | [μm] | [S/m] | [mAh/g] | [mAh/g] | [%] | [%] |
| CE 1 | 500 | Interlayer | 180.41 | 122.92 | 68.1 | 14 |
| | | not used | | | | |
| CE 2 | 20 | Interlayer | 190.74 | 182.75 | 95.8 | 14.8 |
| | | not used | | | | |
| Ex. 1 | 20 | 0.0077 | 195.36 | 182.34 | 93.2 | 0 |

As shown in Table 1, the solid-state secondary battery of Example 1 exhibited improved high-rate performance and no thickness change compared to the battery of Comparative Example 1 (CE1).

Although the solid-state secondary battery of Comparative Example 2 (CE2) demonstrated better high-rate performance than that of Example 1, the battery of CE2 suffered from (or experienced) volume changes, e.g., a cell thickness change of about 15%, during charge/discharge, which negatively impacts its cycle life characteristics. Additionally, any efforts to suppress volume changes during charge/discharge, buffer and pressing components would be required, which reduces the energy density and lowers practical applicability.

Although the disclosure has been described in terms of an embodiment, it is not limited thereto, and it is possible to implement the disclosure by making various modifications within the scope of the claims, the detailed description of the invention, and the attached drawings, and it is obvious that this also falls within the scope of the disclosure.

According to an aspect of the disclosure, a secondary battery is provided which may prevent strain in the thickness direction due to volume change during charging and discharging, and exhibits improved high-rate performance and enhanced energy density.

According to another aspect of the disclosure, a method of preparing a noble secondary battery is provided.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A secondary battery comprising:
an anode current collector comprising a plurality of porous protruded portions and a non-protruded portion disposed between the plurality of porous protruded portions;
a solid electrolyte comprising a plurality of uptake rooms, the plurality of uptake rooms in accommodation with the plurality of porous protruded members and being disposed on the anode current collector; and
an insulating layer between the non-protruded portion of the anode current collector and the solid electrolyte,
wherein the plurality of porous protruded portions comprise a metal-containing framework and an interlayer disposed on at least a portion of a surface of the metal-containing framework.

2. The secondary battery of claim 1,
wherein a porosity of the plurality of porous protruded portions is 70% or more,
wherein the porosity refers to a ratio of an area occupied by pores to a total area of a cross-section of the porous protruded portion.

3. The secondary battery of claim 1,
wherein the porous metal-containing framework comprises copper (Cu), nickel (Ni), stainless steel (SUS), aluminum (Al), indium (In), magnesium (Mg), titanium (Ti), iron (Fe), cobalt (Co), nickel (Ni), zinc (Zn), germanium (Ge) or a combination thereof.

4. The secondary battery of claim 1,
wherein the plurality of porous protruded portions comprise a porous conductive ceramic-containing framework, and
the porous conductive ceramic-containing framework comprises a metal oxide, a metal nitride, a metal nitride, a metal carbide, or a combination thereof.

5. The secondary battery of claim 1,
wherein the plurality of porous protruded portions comprise open pores, and
a pore size of the plurality of porous protruded portions is greater than a width of a frame constituting the metal-containing framework.

6. The secondary battery of claim 1,
wherein a height of the plurality of porous protruded portions is greater than a thickness of the insulating layer, and
a ratio (HP/TP) of the height of the plurality of porous protruded portions (HP) to the thickness of the insulating layer (TI) is 2 or more.

7. The secondary battery of claim 1,
further comprising an insulating layer disposed on a surface of the uptake room.

8. The secondary battery of claim 1,
wherein an aspect ratio of the average diameter to a maximum height of the plurality of porous protruded portions is 1 or more.

9. The secondary battery of claim 1,
wherein a side contour of the plurality of porous protruded portions is defined by a side contour of the uptake room, and
side surfaces of the plurality of porous protruded portions are in contact with side surfaces of the uptake rooms.

10. The secondary battery of claim 1,
wherein the plurality of porous protruded portions are spaced apart from the bottom surface of the uptake rooms.

11. The secondary battery of claim 1,
wherein the height of the plurality of porous protruded portions is greater than a thickness of the non-protruded portions, and
a ratio (HP/TNP) of the height of the plurality of porous protruded portions (HP) to the thickness of the non-protruded portions (TNP) is 2 or more.

12. The secondary battery of claim 1,
wherein the non-protruded portion is porous, and a porosity of the non-protruded portion is less than that of the porosity of the protruded portions, and
a ratio (PNP/PP) of the porosity of the non-protruded portion (PNP) to the porosity of the protruded portions (PP) is 0.8 or less.

13. The secondary battery of claim 1,
wherein the plurality of porous protruded portions are arranged periodically or arranged in a patterned array.

14. The secondary battery of claim 1,
wherein the plurality of porous protruded portions are disposed on a side and an opposite side of the anode current collector, and
the solid electrolyte includes a first solid electrolyte disposed on a surface of the anode current collector and a second solid electrolyte disposed on an opposite surface of the anode current collector.

15. The secondary battery of claim 1,
wherein the insulating layer comprises a metal oxide, and
the metal oxide comprises aluminum oxide (Al₂O₃), titanium dioxide (TiO₂), zirconium oxide (ZrO₂), tin dioxide (SnO₂), zinc oxide (ZnO), silicon dioxide (SiO₂), niobium oxide (Nb₂O₅), tantalum oxide (Ta₂O₅), or a combination thereof.

16. The secondary battery of claim 1,
wherein the insulating layer has a thickness of about 10 nanometers to about 10 micrometers.

17. The secondary of claim 1,
wherein the interlayer is a mixed conductive layer having both ionic conductivity and electronic conductivity, and
the interlayer comprises a material having an ionic conductivity of 10⁻⁸ Siemens per centimeter or more and an electronic conductivity of 4.0×10⁻⁹ Siemens per centimeter or more.

18. The secondary of claim 1,
wherein the interlayer comprises lithium, a carbon-based material, a mixture of a carbon-based material and a metal-based material, a composite of a carbon-based material and a metal-based material, or a combination thereof,
wherein the carbon-based material contains amorphous carbon,
wherein the metal-based material comprises a metal that is distinct from a metal included in the porous metal-containing framework, and
a thickness of the interlayer is 10 micrometers or less.

19. The secondary battery of claim 1,
further comprising lithium metal, a lithium alloy, or a combination thereof, disposed on the plurality of porous protruded portions and within the uptake rooms.

20. A method of preparing a secondary battery, comprising:
applying an interlayer onto at least a surface of a porous anode current collector to provide an interlayer-coated porous anode current collector;
providing a solid electrolyte including a plurality of uptake rooms and an insulating layer disposed between the plurality of uptake rooms;
disposing the solid electrolyte on the porous anode current collector, with the plurality of uptake rooms facing the porous anode current collector to prepare a laminate; and
pressurizing the laminate to accommodate a plurality of protruded portions of the porous anode current collector within the plurality of uptake rooms of the solid electrolyte.
